(19) United States
(12) Patent Application Publication
(10) Pub. No.: US 2025/0022068 A1
(43) Pub. Date: Jan. 16, 2025

(54) Systems and Methods for Asset Analysis

(71) Applicant: Sedna LLC, Charleston, SC (US)

(72) Inventor: Wells Richmond Stecker, Charleston, SC (US)

(73) Assignee: Sedna LLC, Charleston, SC (US)

(21) Appl. No.: 18/895,153

(22) Filed: Sep. 24, 2024

Related U.S. Application Data
(63) Continuation-in-part of application No. 16/944,527, filed on Jul. 31, 2020.
(63) Continuation-in-part of application No. 17/352,198, filed on Jun. 18, 2021.

(51) Int. Cl. G06Q 40/10; G06Q 30/0201; G06Q 50/16

(52) U.S. Cl. CPC G06Q 40/10; G06Q 30/0206; G06Q 50/16

(57) ABSTRACT

Systems and methods for automatic cost segregation analysis. A method includes obtaining user input presenting a number of real property assets. The user input can be indicative of a selected asset from the number of assets. The method can include obtaining an asset profile for the selected asset from a first database, and historical data associated with the asset from a second database. The asset profile for the selected asset can be previously generated for the asset based on asset data compiled from a number of external sources. The method can include automatically generating a cost segregation estimate for the selected asset based on the asset profile and the historical data. The method can include automatically displaying data indicative of the segregation estimate in response to the user input. The specialized user interfaces described herein allow for automatic segregation analysis and the generation of letters to property owners with minimal user interaction.

### STATEMENT OF RELATED APPLICATIONS

This application is filed as a continuation-in-part of U.S. Ser. No. 16/944,527 entitled “Systems and Methods For Asset Analysis.” That application was filed on Jul. 31, 2020.

This application is also filed as a continuation-in-part of U.S. Ser. No. 17/352,198 entitled “Systems and Methods For Asset Analysis.” That application was filed on Jun. 18, 2021.

The '527 application and the '198 application are co-owned and have a common inventor, to wit, W. Richmond Stecker.

Each of these prior applications is incorporated herein in its entirety by reference.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### BACKGROUND OF THE INVENTION

This section is intended to introduce selected aspects of the art, which may be associated with various embodiments of the present disclosure. This discussion is believed to assist in providing a framework to facilitate a better understanding of particular aspects of the present disclosure. Accordingly, it should be understood that this section should be read in this light, and not necessarily as admissions of prior art.

### FIELD OF THE INVENTION

The present disclosure relates to the field of specialized user interfaces for asset analysis. More specifically, the present invention relates to asset analysis and valuation for purposes of cost segregation.

### Discussion of Technology

The tax laws allow the owner of real estate to write off depreciation of the investment from their income taxes over a period of time. Depreciation is a deduction that real estate investors can claim on their income taxes each year to help them recover the cost of owning, operating and maintaining that property.

The amount of depreciation or the time frame for the depreciation generally varies depending on the type of investment. Through a process known as cost segregation, the owner or investor may speed up the depreciation schedule, increasing the amount that can be deducted each year. By using this strategy, the investor can reduce the amount of money owed on income taxes each year.

Cost Segregation is the process of separating asset components based on their useful class lives for the purpose of justifying enhanced depreciation. This is referred to as a Cost Segregation Study. Conventional cost segregation studies involve estimation techniques based on an analysis of an asset's visual characteristics. This tends to be a manual and cumbersome process. Such predictions rely on the unique experiences and subjective valuations of the estimator, thus resulting in disparate and inaccurate outcomes for individual assets.

### SUMMARY OF THE INVENTION

Aspects and advantages of embodiments of the present disclosure will be set forth in part in the following description, or may be learned from the description, or may be learned through practice of the embodiments.

One aspect of the present disclosure is directed to a computer-implemented method for conducting a cost segregation study. The method includes obtaining, by a computing system comprising one or more computing devices, user input indicative of a selected asset from a user. The method includes obtaining, by the computing system, an asset profile for the selected asset from an asset database. The asset database can include asset data associated with a plurality of assets. The asset profile can be previously generated for the selected asset based on the asset data.

The method may also include obtaining, by the computing system, historical segregation data associated with the selected asset from a historical database. The historical database includes data indicative of previous segregation studies for one or more of the plurality of assets. The method can include automatically generating, by the computing system, a holistic cost segregation estimate for the selected asset based on the asset profile and the historical segregation data together. The method then includes providing for display to the user, by the computing system, the holistic cost segregation estimate using a graphical user interface.

In one aspect, the method further includes sending the holistic cost segregation estimate to the owner of the selected real property asset using the owner's contact information. The contact information may represent the owner's home or business. Additionally, the method may comprise receiving a communication from the owner concerning cost segregation services. Thereafter, the method includes conducting an on-site investigation of the selected real property asset.

The on-site investigation can include conducting an engineering study of the real property asset to determine which portions of the selected real property asset are subject to 5-year depreciation and which portions of the selected real property asset are subject to 15-year depreciation. From the engineering study, an engineering report is prepared that is suitable for submission to the Internal Revenue Service.

The method also comprises, based on the on-site investigation and the engineering report, generating a cost segregation study for the owner. Of course, the cost segregation study may also be a more accurate update of the prior cost segregation estimate.

Another aspect of the present disclosure is directed to a computing system used for preparing a cost segregation estimate. The computing system comprises an asset database including (i) asset data associated with a plurality of assets, and (ii) a historical database representing historical segregation data indicative of a plurality of previous cost segregation studies for various real estate assets. In addition, the computing system can include one or more display devices, one or more processors, and one or more non-transitory computer-readable media that collectively store instructions that, when executed by the one or more processors, cause the system to perform operations. The operations can include providing for display to a user, via the display device, a first user interface presenting one or more of the plurality of assets for selection by the user. The operations then include obtaining, via the first user interface, a selection user input indicative of a plurality of selected assets. The operations also include obtaining an asset profile for the selected assets from the asset database. The asset profiles can be previously generated based, at least in part, on a portion of the asset data corresponding to the selected assets.

In response to the selection user input, the operations can include automatically generating a holistic cost segregation estimate for the selected real estate assets based, at least in part, on the asset profiles for the selected assets and the historical cost segregation data. The operations may also include the step of providing for display to the user, via the one or more display devices, a second user interface presenting at least one of the asset profiles or the holistic cost segregation estimates for the selected real estate assets.

In one aspect, the operations may further include, in response to user input, generating a digital file comprising a plurality of real estate assets having selected asset attributes, wherein the attributes comprise the owners of the respective real estate assets and the contact information of the owners. The digital file represents a Marketing Campaign. The operations further include automatically sending cost segregation estimates to the owners listed in the Marketing Campaign using the contact information, wherein the cost segregation studies correlate to the respective owners and their real estate assets.

Another aspect of the present disclosure is directed to a computer-implemented method of preparing a cost segregation study. The computer-implemented method can include obtaining, by a computing system comprising one or more computing devices, search criteria indicative of one or more real property asset attributes. The method also includes providing for display, by the computing system via one or more display devices, a first user interface presenting a visual representation of a plurality of the real property assets, together forming a Marketing Campaign. Each of the plurality of real property assets is associated with or includes the one or more asset attributes.

The method further comprises automatically generating, by the computing system, a cost segregation estimate for the asset. The method further includes sending the holistic cost segregation estimates to the owners of the selected real estate assets using the owner's contact information. Preferably, the step of sending the cost segregation estimates to the owners includes preparing and including cover letters to the owners.

Additionally, the method may comprise receiving a communication from one or more of the owners concerning cost segregation services. This is in response to receiving the cover letters. Thereafter, the method includes conducting an on-site investigation of the real estate assets of each of the contacting owners.

The on-site investigation can include conducting an engineering study of each of the real estate assets to determine which portions of the selected real estate assets are subject to 5-year depreciation and which portions of the selected real estate assets are subject to 15-year depreciation. From the engineering studies, engineering reports are prepared that are suitable for submission to the Internal Revenue Service.

The method also comprises, based on the on-site investigations and the engineering reports, generating a cost segregation study for each of the respective owners. The cost segregation studies are suitable for filing with the Internal Revenue Service along with any appropriate filing forms, and can be used by a CPA to change the depreciation basis for the owners' respective real estate assets.

Finally, the method may also include storing, by the computing system in an accessible memory, data indicative of the asset and the generated segregation estimate.

Other examples aspects of the present disclosure are directed to apparatus, methods, electronic devices, non-transitory computer-readable media, and systems. These and other features and advantages of embodiments will become better understood with reference to the following description. The accompanying drawings, which are incorporated in and constitute a part of this specification, illustrate embodiments of the present disclosure and, together with the description, serve to explain aspects of the invention.

### BRIEF DESCRIPTION OF THE DRAWINGS

FIG. 1 depicts an example of a computing system of the present disclosure, in one embodiment.

FIG. 2 depicts a system flow diagram for generating asset profiles according to an embodiment of the present disclosure.

FIG. 3A is a schematic diagram showing search criteria options displayed on an illustrative display device.

FIG. 3B is another schematic diagram showing search criteria options displayed on an illustrative display device.

FIG. 4 presents a display device showing a list of illustrative assets. The assets are preferably real estate properties.

FIG. 5 presents a display device again showing a list of illustrative assets. In this case, search features including filters are provided for searching real estate properties.

FIG. 6 depicts a data flow diagram for generating depreciation data according to embodiments of the present disclosure.

FIG. 7 depicts an example relationship between attributes of an asset profile according to example embodiments of the present disclosure.

FIG. 8 is a flow chart showing a method for automatically generating a cost segregation estimate according to embodiments of the present disclosure.

FIG. 9 depicts a block diagram of example computing hardware which may be used in the methods herein.

FIGS. 10A and 10B together present a single flow chart for a method of generating a cost segregation study.

### DETAILED DESCRIPTION OF CERTAIN EMBODIMENTS

### Detailed Description

Reference now will be made to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Example aspects of the present disclosure are directed to improved systems and methods for automatically performing cost segregation analysis on a plurality of assets, such as real estate properties or holdings. In particular, example systems and methods of the present disclosure can automatically generate holistic and accurate cost segregation estimates for a number of assets (e.g., real estate properties, groups of properties (e.g., multiple addresses) associated with the same ownership and/or transaction) with minimal to no user input. To do so, a computing system provides a user search interface for searching a plurality of assets across a plurality of counties and even a plurality of States based on search criteria. Such criteria may include purchase price, location, ownership, and type of property.

The computing system receives a search query (e.g., via user input to the user search interface) and provides for display (e.g., via a results user interface) a number of assets with one or more attributes corresponding to the search query. The computing system can receive a selection of a selected asset (e.g., via the user interface) and automatically generate a cost segregation estimate for the selected asset. The computing system can provide information corresponding to the selected asset and one or more portions of the cost segregation estimate for display to a user on a display device.

In this manner, aspects of the present disclosure present an improved user interface for computing devices. Unlike conventional user interface techniques, the computing system employs a user-interface that is capable of automatically performing cost segregation analysis with little to no user input. In this manner, the computing system can increase the speed and simplicity of cost segregation analysis by reducing the complexity of user interactions required to perform cost segregation estimates. Moreover, as discussed in detail herein, the resulting cost segregation estimates of the present disclosure improve the accuracy of cost segregation estimates generated using conventional techniques. As a result, the disclosed technology provides the practical application of improving the accuracy of conventional cost segregation estimates while reducing the time and complexity of generating such estimates by enabling the automatic generation of estimates via simplified user interactions.

Aspects of the present disclosure provide an improvement to computing technology. For instance, the user interfaces described herein can facilitate the generation of holistic cost segregation estimates using fewer user interactions with the computing system. This, in turn, allows for preservation of computing resources for one or more other core functions such as the generation of the holistic cost segregation estimates. Unlike conventional cost segregation estimation techniques, the computing system disclosed herein generates holistic cost segregation estimates based on asset features and historical cost segregation data, including publicly available data provided by local tax assessor collector offices, and not solely through data input by the user. To do so, the computing system maintains an asset database including a previously determined and continuously updated asset profile for each of a number of assets that identify verified, relevant information for a respective asset. The asset profile can include a number of asset attributes for a respective asset. Each attribute can be determined based on historical asset data, typically purchase price information, and verified (e.g., based on a confidence threshold) before being added to a respective asset profile. The asset profile can be continuously updated e.g., daily or weekly, with one or more new and/or modified attributes as information becomes available.

In addition, the computing system can maintain a historical cost segregation database storing historical segregation data including a plurality of unverified cost segregation estimates and verified cost segregation studies for one or more of the plurality of assets. The computing system can generate a holistic cost segregation estimate for a selected asset by comparing the asset profile to the historical segregation data. In this manner, the computing system can determine highly accurate cost segregation estimates automatically.

### DESCRIPTION OF SPECIFIC EMBODIMENTS

The computing system utilizes a rules-based approach for generating a holistic cost segregation estimate for a selected asset, or property. For instance, the computing system may determine at least three different sets of data, representing use depreciation data, group depreciation data, and optimal depreciation data. Each set of rules can include a different comparison between the asset profile of the selected asset with the historical cost segregation data.

The computing system may include additional sets of rules to generate additional data, such as benefits analysis and segregation schedules to generate robust cost segregation estimates. In this manner, the computing system uses a combined order of specific rules that render asset information and historical cost segregation information into a usable format that can be applied to create a new and more accurate cost segregation analysis.

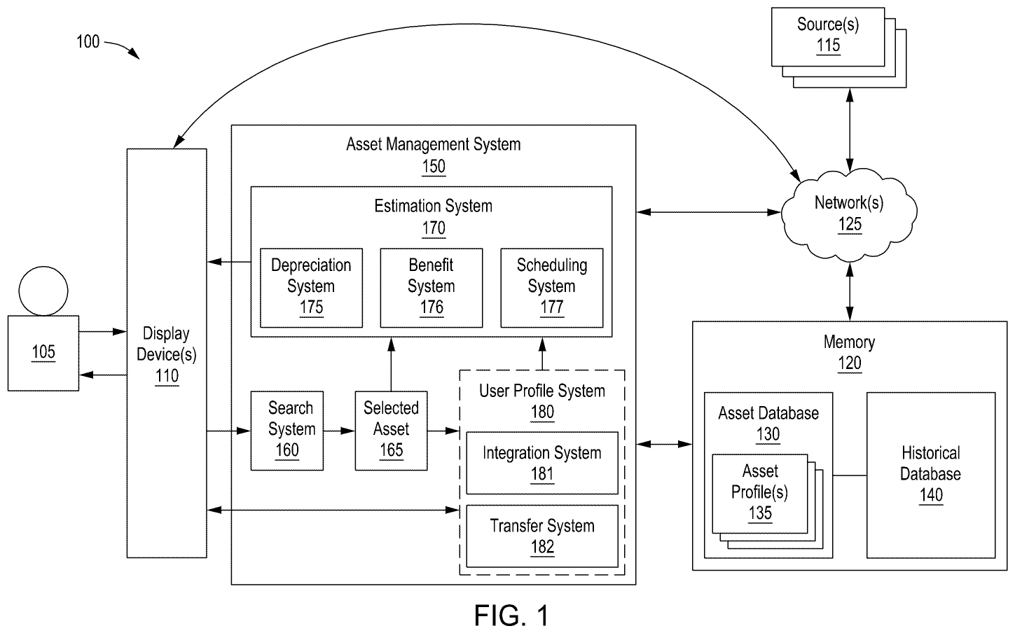

FIG. 1 depicts a computing system 100 of the present disclosure, in one embodiment. The computing system 100 includes an asset management system 150, one or more display device(s) 110, and a user 105 that can interact with the asset management system 150 via the one or more display device(s) 110. The computing system 100 also comprises one or more external data sources 115, and an accessible memory 120. In some implementations, the asset management system 150 can include the display device(s) 110 and the accessible memory 120 (e.g., RAM). In addition, or alternatively, the asset management system 150 can communicate with the display device(s) 110, the accessible memory 120, and the external data sources 115 via one or more networks 125.

The networks 125 may be any type of network or combination of networks that allows for communication between systems and/or devices thereof. In some implementations, the networks 125 can include a local area network, a wide area network, the Internet, a secure network, a cellular network, a peer-to-peer communication link, or some combination thereof. Communication over the networks 125 can be accomplished, for instance, via a network interface using any type of protocol, protection scheme, encoding, format, or packaging, and may be wired or wireless.

The accessible memory 120 can include an asset database 130 storing one or more asset profiles 135 and a historical database 140. The asset management system 150 can include one or more subsystems such as, for example, a search system 160, a user profile system 180, and an estimation system 170. The user profile system 180 may include an integration system 181 and/or a transfer system 182. Moreover, the estimation system 170 can include a depreciation system 175, a benefit system 176, and/or a scheduling system 177.

The asset management system 150 and/or one or more of its subsystems thereof can include one or more computing devices configured to communicate over one or more wired and/or wireless networks. Each computing device can include one or more processors and one or more non-transitory computer-readable media that collectively store instructions that, when executed by the one or more processors, cause the devices to perform operations. In some implementations, each of the subsystems 160, 170, 180 can include one or more subroutines or software processes of the asset management system 150. The asset management system 150 and/or the one or more subsystems can be implemented on one and/or across a plurality of communicatively connected devices such as one or more backend servers.

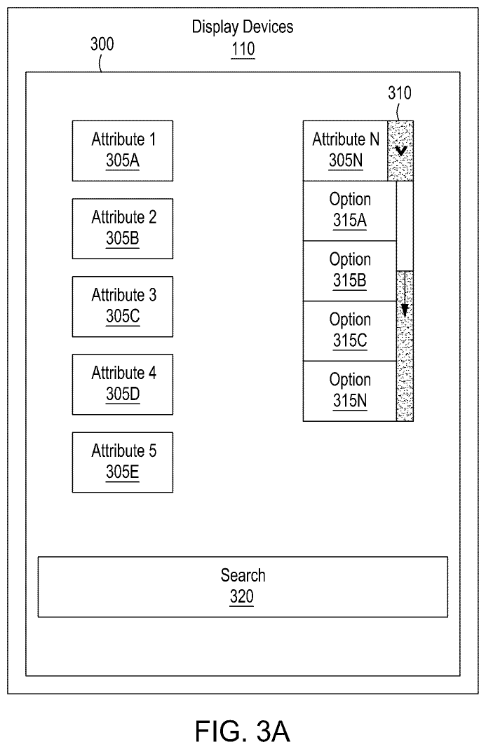

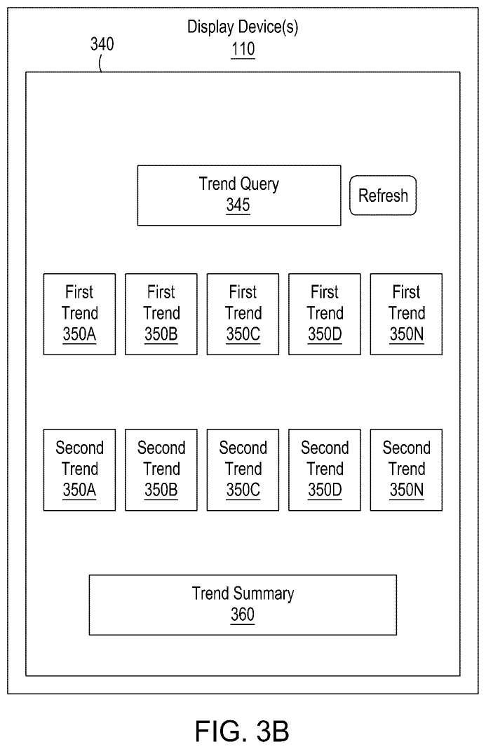

The one or more display devices 110 can include one or more local display devices such as a monitor, and/or one or more remote display devices such as a portable wireless user device (e.g., a smartphone, a tablet, or a laptop). The display devices 110 can be configured to display one or more interactive user interfaces (e.g., as discussed in further detail herein with reference to FIGS. 3, 4, and 7). A user 105 can interact with user interfaces presented by the display devices 110 to view data presented by the user interfaces and to provide user input (e.g., one or more touch inputs via a touch screen or one or more widgets) to the asset management system 150 and/or one or more subsystems 160, 170, 180 thereof.

For example, a user 105 can access an application implemented on a user device. The application can include, for example, a client application with access to one or more functions (e.g., subsystems 160, 170. 180) of the asset management system 150. The user 105 can interact with one or more specialized graphical user interfaces of the application to manage assets associated with the accessible memory 120. An asset, for example, can include a property or groups of properties. An asset may include a group of real estate properties associated with a similar owner or transaction but identified by multiple addresses.

In one aspect, a user 105 may interact with the user interfaces to select an asset 165 from the accessible memory 120 and automatically determine a cost segregation estimate for the selected asset 165. For instance, a cost segregation estimate can be made for a group of properties of the selected asset and, in some implementations, each individual property associated with the group of properties. The selected asset 165, information corresponding to the selected asset 165 such as an asset profile 135, and/or the cost segregation estimate for the select asset 165 can be provided to a display device 110 to be displayed to the user 105.

The asset management system 150 is programmed to automatically determine the cost segregation estimate associated with the selected asset 165 based on data stored by the asset database 130 and/or the historical database 140. For instance, the accessible memory 120 can include one or more databases storing information associated with a plurality of assets. The one or more databases can include the historical database 140 and the asset database 130. The asset database 130 can include an asset profile 135 for each of the plurality of assets. The asset profile 135 can include one or more verified asset attributes associated with a respective asset. The asset profiles 135 can be previously generated for each of the plurality of assets. In some implementations, the asset profiles 135 can be continuously updated or periodically updated, capturing new data along the way. Such updating may occur, for example, once a week.

Beneficially, the computing system 100 may optionally be disconnected from a server and operate independently. In this respect, the accessible memory 120 may be specially configured to include 128 Gigabytes (or more) of operating capacity, or RAM. The accessible memory 120 may further be specially configured to offer one Terabyte (or more) of disc space. This additional accessible memory may be installed into a specially-configured laptop.

Optionally, the computing system 100 may include an additional two Terabytes of disc space on an external solid state disc drive. Either way, this unique arrangement allows the operator to operate the asset management system 150 without having it hosted on a server and without connecting to networks 125.

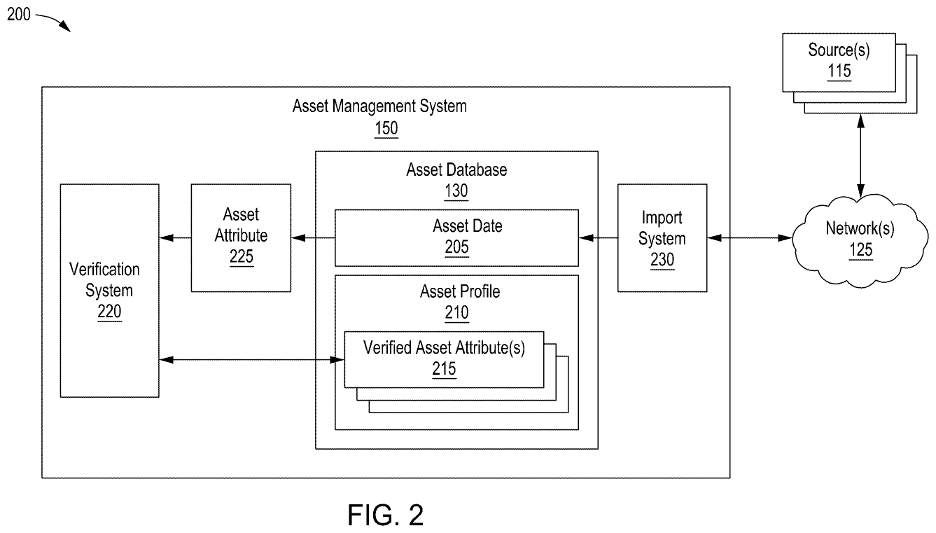

FIG. 2 depicts a system flow diagram 200 for generating asset profiles according to the present disclosure, in one embodiment. In FIG. 2, the asset management system 150 is again shown in communication with the one or more external data sources 115 via the networks 125.

The asset database 130 is also shown. The asset database 130 includes asset data 205 and plurality of asset profiles 210. The asset profiles 210 may be verified asset attributes 215. Using an import module 230, the asset management system 150 may import asset data 205 via the one or more networks 125 from the external sources 115. The external sources 115 can include a plurality of disparate databases stored on one or more remote computing devices or servers. Each of the external sources 115 can include property and/or transaction related information for one or more real estate assets. For instance, the external sources 115 can include resources offered by county reporter offices, tax reporter offices, and any other resource that provides property and/or transfer information.

The import system 230 can be configured to access, via the networks 125, the external sources 115 to obtain the asset data 205 and import the asset data 205 to the asset database 130. In some implementations, the import system 230 can be configured to automatically import additional asset data on an importation schedule. The importation schedule can define a frequency with which the import system 230 can import addition asset data for updating the asset database 130. The importation schedule can include any recurring time period such as, for example, an hourly, daily, weekly, or monthly time period. In this manner, the import system 230 can work unattended to import asset data from the one or more external sources 115 to the asset database 130.

The import system 230 can be configured to analyze newly-imported asset data to determine one or more purchasing trends. For instance, the import system 230 can determine which State (e.g., of the United States) has had the most purchases in the past 30 days (e.g., based on owner addresses), which owners have made the most purchases, the newest transactions that occurred in a previous day, week, or month, mortgage rates, and other purchasing trends. By way of example, the purchasing trends can include the top five States with the most transactions over a specific time period, the top property group with the most transactions within each of the top five States over the specific time period, and/or a summary of the total property transactions and/or top five property groups within the total property transaction. Such purchasing trends can be determined with the same frequency in which the import system 230 can import additional asset data and can be stored in the asset database 130.

Purchasing trends can be displayed to a user of the asset management system 150. In this manner, users can target assets which are the most popular (e.g., based on which State had the most recent purchases), recognize increased purchasing activity, identify purchasing trends and mortgage rates to determine how much money is left on mortgages, which rates are being paid, and so forth.

In a preferred embodiment, the asset data 205 includes a plurality of asset attributes 215. Asset attributes may include historical, transactional, and/or tax related information corresponding to an asset. By way of example, an asset attribute can be indicative of at least one of location data, ownership data, price data, a group classification, a use classification, a footprint, and depreciation data.

An asset attribute indicative of location data, for example, may represent the physical address of the asset.

An asset attribute indicative of ownership data may represent the current and previous owners of the asset along with, for example, the owner type (e.g., individual, business, or non-profit. Ownership data may also represent each owner's residency, name, and contact information (e.g., mailing address, email address, or phone number.

An asset attribute indicative of price data may represent purchase prices corresponding to sales of a real estate asset over time. This may also include the lender, the interest rate, and other mortgage information.

An asset attribute indicative of a use classification may represent a designated use code. An example might be a municipality code assigned to the asset by a respective municipality and/or any other classification associated with the use of an asset. Zoning restrictions may also be included.

An asset attribute indicative of a group classification can identify a group classification assigned to the asset, as described in greater detail herein.

An asset attribute indicative of a footprint can identify a lot size and/or a building size of a property.

The asset data 205 can include a plurality of attribute values for each attribute of an asset. For example, the asset data 205 can include an asset attribute value for a respective attribute as recorded during one or more transfers of ownership of the asset, during one or more tax events involving the asset, or during one or more cost segregation evaluations. In some cases, the asset attribute values can be no longer current, or redundant, misleading, or even incorrect. To improve the speed and efficiency of generating a cost segmentation estimate and increase the accuracy thereof, the verification system 220 may generate an asset profile for each asset of the asset database 130 based on the asset data 205. The verification system 220 may be configured to discriminate duplicates and/or invalid data to generate the asset profile 210.

The verification system 220 may obtain an asset attribute 225 from the asset data 205, and then compare one or more values of the asset attribute 225 to verify the asset attribute 225. For example, the verification system 220 can determine a confidence score for the asset attribute 225 based on one or more asset attribute values corresponding to the asset attribute 205. The verification system 220 may determine a higher confidence score for an asset attribute with a number of redundant (e.g., repeating) values, a value reported by a trusted external source, and/or any other indicia of trustworthiness. In addition, or alternatively, the verification system 220 may determine a lower confidence score for an asset attribute with a number of contradicting values or other indicia of untrustworthiness. In like manner, the verification system 220 can determine a confidence score for each different value corresponding to the asset attribute 225. For example, the verification system 220 can assign the value associated with the highest value confidence score to the asset attribute 225.

The verification system 220 can add the asset attribute 225 (e.g., with the value associated with the highest confidence score) to the asset profile 210 if the asset attribute 225 is assigned an attribute confidence score higher than a confidence score threshold. The confidence score threshold can be a predetermined value (e.g., 50% or 70%) for each asset attribute and/or dynamically determined based on the asset attribute (e.g., a higher threshold for asset attributes indicative of location data, a lower threshold for asset attributes indicative of use classifications). The asset management system 150 can generate the asset profile 210 based, at least in part, on the confidence score for each of a plurality of asset attributes corresponding to an asset.

In one embodiment, an asset attribute assigned a confidence score under the confidence score threshold can trigger a manual review. During the manual review, a manually verified value can be assigned to the asset attribute. In this manner, the asset profile 210 for an asset can include one or more verified asset attributes 215 associated with a respective confidence score above a confidence threshold. Moreover, manually verified values can subsequently be used to automatically determine one or more attribute values and/or confidence scores for other asset attributes such that the verification system learns to accurately verify one or more attributes over time.

In some implementations, the asset management system 150 can determine a confidence score for a use classification attribute associated with an asset. The system 150 can verify the use classification based on the confidence score. In the event that the confidence score is below a confidence threshold, the system 150 can determine one or more alternative use classifications for the asset based on one or more asset attributes of the asset. By way of example, the system 150 can include one or more models coded to determine one or more use classifications for an asset based on the one or more asset attributes of the asset. In this manner, an asset profile 210 can include a plurality of use classifications.

The asset database 130 may include a plurality of previously generated and continuously maintained asset profiles 215. The asset management system 150 can compile asset data 130 over time into one record such that all available, current, and accurate asset information is accessible. In so doing, the asset profile 210 can provide a comprehensive overview of all available, current, and accurate attributes that have been reported to one or more external sources 115 over a number years and/or determined for the asset by the system 150 based on one or more other assets attributes.

Turning back to FIG. 1, the accessible memory 120 optionally includes a historical database 140. The historical database 140 can include historical cost segregation data indicative of a plurality of previous cost segregation studies for one or more of the plurality of assets. By way of example, the historical database 140 can track previously determined allocations to five and fifteen year property for an asset (e.g., depreciation data). In addition, the historical database can include corresponding asset data associated with the previously determined allocations such as, for example, the square footage of the lot and building, property group, type, and municipality of the asset for which the previous cost segregation study was performed

Beneficially, a cost segregation estimate for the selected asset 165 can be automatically generated based, at least in part, on the historical cost segregation data. In some implementations, the cost segregation estimate can be stored in the historical database 140. In this manner, additional cost segregation estimates can be automatically generated based, at least in part, on previous cost segregation estimates such that the accuracy and scope of newly generated cost segregation estimates increases over time.

Additionally, the asset management system 150 may automatically generate a new cost segregation estimate for the selected asset 165 based, at least in part, on user input. For example, the asset management system 150 can obtain user input indicative of the selected asset 165 from user 105. To do so, the asset management system 150 can provide for display to the user 105, via the one or more display devices 110, a user search interface presenting one or more search criteria options. By way of example, FIGS. 3A and 3B depict example user interfaces 300 and 340 presenting search criteria options according to example embodiments of the present disclosure. With reference to FIG. 3A, the user search interface 300 can be provided to the user via the display device 110. The interface 300 can include a plurality of interactive widgets 305A-N with which a user can create a search query using, for example, interactive buttons, a drop down box, or text input box.

The widgets 305A-N can include a separate widget for each of one or more attributes of an asset 165. For example, interface 300 can include a widget for each attribute 165 corresponding to at least one asset profile 210 of the asset database 130. By way of example, a widget 305A can include an interactive component configured to accept footprint criteria (e.g., a maximum/minimum lot size, maximum/minimum building size, and/or a range thereof), transaction criteria (e.g., a specific transaction date (e.g., last purchase date, sale date, etc.), transactions within a range of time (e.g., assets that have been purchased, sold, etc. within the last year, two years, between two and three years ago, etc.), etc.), price criteria (e.g., minimum/maximum last sales price, etc.), age criteria (e.g., minimum/maximum year built), location criteria (e.g., specific address, minimum/maximum distance from user, one or more different states, counties, municipalities, cities, zip codes, etc.), owner criteria (e.g., residency (e.g., as determined from the owner's mailing address), name, type (e.g., individual, business, non-profit, etc.), etc. of the owner of the asset), asset group classification criteria (e.g., assets that fall within one or more group classifications, assets that do not fall into one or more group classifications, etc.), use classification (e.g., assets that fall within one or more use classifications, assets that do not fall into one or more use classifications, etc.), and/or any other criteria associated with one or more assets of the asset database.

As one example, a widget (e.g., widget 305N) can include an interactive component with a drop down option 310 presenting one or more search options 315A-N for an attribute. By way of example, a widget (e.g., widget 305N) configured to accept group classification criteria can present a plurality of group classification options for selection by the user. The user can select one or more of the plurality of search options 315A-N to identify search criteria for an asset query. In addition, or alternatively, the user can interact with any number of different types of interactive widgets (e.g., interactive components such as text boxes) to select different search criteria for an asset query.

In this manner, the asset management system 150 can obtain search criteria indicative of one or more asset attributes 215. For instance, the asset management system 150 can obtain, via the user search interface 300, query user input indicative of the search criteria for one or more of the plurality of assets 165 of the asset database 130. As an example, the search criteria can include at least one of location data, ownership data (e.g., the mailing address of the owner), price data, a group classification, a use classification, footprint data (that is, building size or lot size), depreciation data, and/or any other data associated with an asset of the asset database. By way of example, the query user input can include a selection of one or more different search criteria presented by the user search interface 300. The user can provide the query user input to establish the search criteria for an asset query and select a search option 320 presented by the user search interface 320 to initiate the asset query. In this manner, the asset management system 150 allows a user to query assets 165 based on different parameters such that the user can target selected areas, purchases, owners, and the like.

With reference to FIG. 3B, a home interface 340 can be provided to the user via the display devices 110. The interface 340 can include a plurality of interactive widgets (e.g., interactive buttons, drop down box, or text input boxes) with which a user can interact to create a trend query 345. The trend query 345, for example, can include a specific time frame (e.g., within one or more days, months, years, or a range between two specific dates) with which to determine one or more purchasing trends. The user can interact with the interactive widgets to select a trend query 345 to initiate. In this way, the home interface 340 can act as a real time real estate analytic tool that allows the user to pinpoint trending areas and property types being purchased with a dynamically set time frame.

In response to the user input, the asset management system 150 can provide for display, via the home interface 340, one or more purchasing trends with the set time frame. By way of example, the purchasing trends can include one or more first trends 350A-N (e.g., the top five States with the most transactions during the set time frame, etc.), one or more second trends 355A-N (e.g., the top property group with the most transactions in each of the five States, etc.), and/or a trend summary 360 (e.g., the overall purchases during the set time frame and/or the top overall property groups within the set time period, etc.). In some implementations, the home interface 340 can include an interactive map. In such a case, the one or more purchasing trends can be provided for display in relation to one or more geographic locations (e.g., States) associated with the purchasing trends 350A-N, 355A-N via the interactive map interface.

In some implementations, the user can interact with the one or more purchasing trends 350A-N, 355A-N to provide search criteria for an asset query. For instance, the user can select a purchasing trend 350A to identify search criteria associated with the purchasing trend 350A. By way of example, the first purchasing trend 350A can identify the State with the most transactions during a set time frame. In such a case, home query input directed to the presented first purchasing trend 350A can identify search criteria including the set time frame and the State. In this manner, the home interface can enable a user to query specific assets (e.g., to view asset and to generate a cost segregation estimate) based on one or more recent trends associated with the plurality of assets 165 of the asset database 130. This, in turn, can enable more informed queries to a plurality of assets.

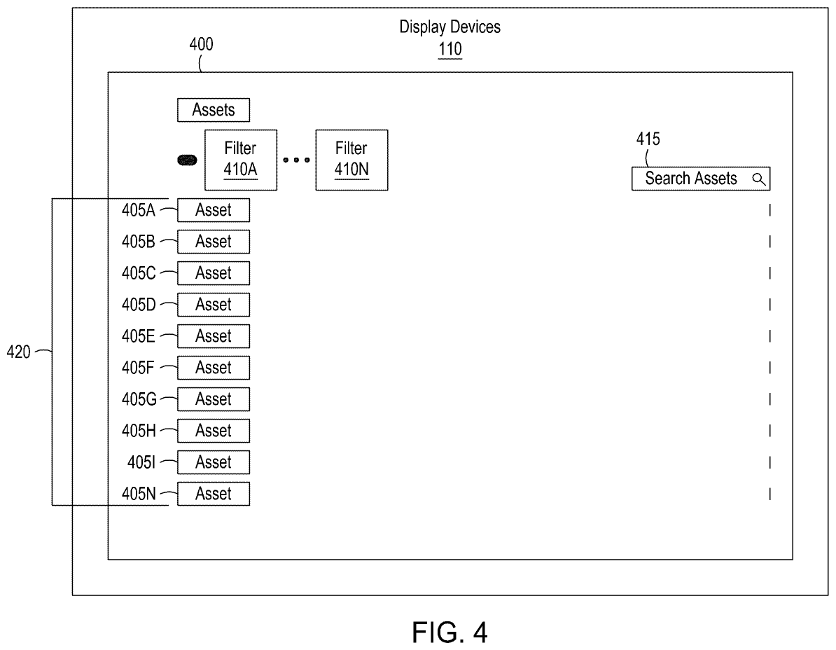

FIG. 4 depicts a user interface 400 presenting a series of assets 405A-N. The search system 160 of the asset management system 150 is able to identify one or more of the plurality of assets based, at least in part, on the search criteria. The search system 160 can generate a subset of assets 405A-N to be displayed to the user based on the search criteria. Each of the assets of the subset of assets 405A-N, for example, can satisfy one or more of the search criteria. By way of example, each of the assets 405A-N can be associated with an asset profile with one or more asset attributes achieving the search criteria (e.g., an age attribute with an age range, an owner attribute identifying a selected state residency, or attributes corresponding to a selected trend). In this manner, the asset management system 150 (e.g., search system 160) enables a user to query asset information and related transactions from the asset database and/or, in some implementations, directly from an external source.

The search system 160 can provide for display to the user, via the one or more display devices 110, a results user interface 400 presenting one or more of the plurality of assets for selection by the user. The one or more assets, for example, can include the subset of assets 405A-N identified in response to the search criteria. By way of example, the results user interface 400 can present a selectable list 420 of the subset of assets 405A-N. Thus, the search system 160 can provide for display, via one or more display devices 110, a user interface 400 presenting a visual representation of the assets 405A-N for selection by a user. As described herein, each of the assets 405A-N can be associated with the one or more asset features.

In some implementations, the results user interface 400 can include one or more additional interactive components. By way of example, the results user interface 400 can include one or more order widgets 410A-N and/or a sub search options 415. Each of the one or more order widgets 410A-N can organize the assets 405A-N based on one or more criteria such as, for example, each asset's address, owner, owner type, property group, municipality code, sale date, sale amount, and/or any other asset attribute corresponding to the assets 405A-N. The sub search option 415 can add additional criteria to the search criteria of the asset query. In this manner, the results user interface 400 can enable a user to search for one or more assets within the subset of assets 405A-N. The user can interact with the selectable list 420 of the assets 405A-N to select an asset. In this manner, the asset management system 150 can receive a selected asset.

Turning back to FIG. 1, the asset management system 150 can obtain (e.g., via the results user interface 400 of FIG. 4) a selection user input indicative of the selected asset 165. The selection user input can be an input identifying an asset from the assets 405A-N presented by the user interface 400. The selected asset 165, for example, can include at least one asset of the displayed assets 405A-N. The estimation system 170 of the asset management system 150 can automatically generate a cost segregation estimate for the selected asset 165 in response to the selection user input. In addition, or alternatively, the estimation system 180 of the asset management system 150 can, in response to the user input, provide for display to the user 105, via the one or more display devices 110, a user profile option interface presenting one or more user profile options for selection by the user 105.

The user profile options, for example, may include a personal user profile and/or a commercial user profile option. The user 105 can interact with the user profile option interface to add the selected asset 165 to a personal file for personal review and/or a sales file (e.g., by interacting with a commercial profile option) for adding contact information and notes. Each profile can be associated with one or more previously selected assets. In addition, each profile can include one or more interactive widgets to view an asset profile of a selected asset, edit the asset profile of the selected asset, delete the selected asset from the assets associated with the profile, convert, via the integration system 181, information associated with the selected asset to a letter for transmittal to one or more clients (e.g., an owner of an asset, etc.), and/or transfer, via a transfer system 182, the information associated with the selected asset to one or more remote applications (e.g., other applications such as excel or Salesforce).

For example, if a user wants to target certain types of assets in certain areas, the user can query those assets and create a commercial profile for them. Once the commercial profile is complete, the user can download one or more client letters, via the integration system 181, with cost segregation estimate information attached thereto. In some implementations, the integration system 181 can be configured to automatically mail and/or email the one or more client letters to the one or more clients.

In one aspect, the user profile system 180 can obtain, via the user profile option user interface, user profile input indicative of a user profile option. The user profile option can be indicative of the user's intention to supplement a personal user profile and/or one or more commercial user profile(s) (e.g., a commercial profile for each group of assets) with the selected asset 165. By way of example, the user 105 can be associated with the personal user profile and/or the one or more commercial user profiles. The personal user profile can include a personal subset of assets for the user's personal review. Each of the commercial user profiles can include a subset of assets grouped by one or more criteria (e.g., one or more attributes such as State or asset type) and supplemented with contextual information such as contact information.

The user profile system 180 can enable the user 105 to group assets into a personal profile or a commercial profile for additional asset management. When a selected asset 165 is added to a profile, the estimation system 170 can automatically generate a cost segregation estimate for the selected asset 165. In addition, the estimation system 170 can generate a client profile for the asset in which the user 105 can add contact events such as phone calls, emails, update contact information, and generate a new cost segmentation estimate based on additional asset information.

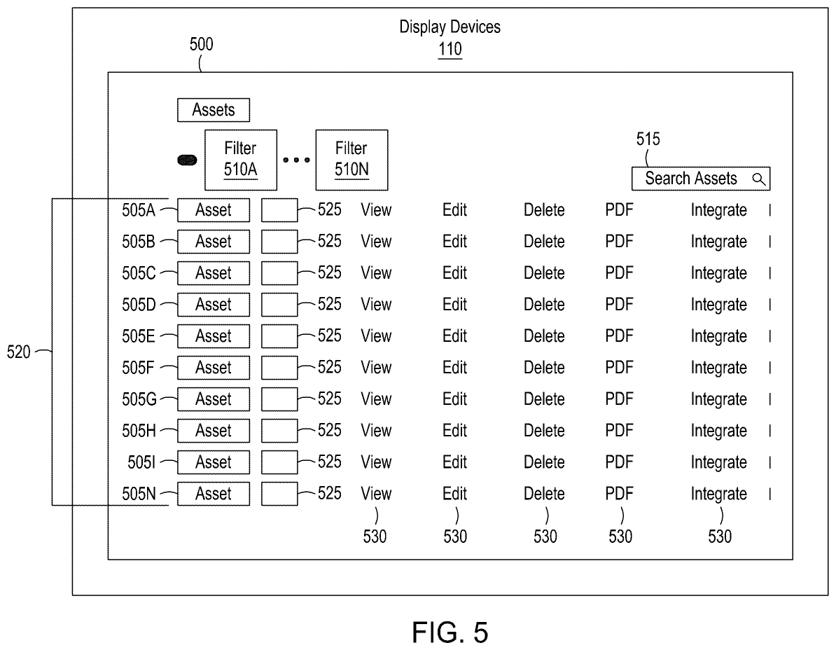

FIG. 5 depicts an illustrative user profile interface 500. The user profile interface 500 includes a selectable list 520 of one or more previously-selected user assets 505A-N. In addition, the user interface 500 presents asset information 525 for each of the one or more user assets 505A-N. The asset information 525 can include at least one of a respective asset profile and/or a respective holistic cost segregation estimate for an asset (e.g., selected asset 165). In some implementations, the user profile interface 500 can include one or more additional interactive components. By way of example, the user profile interface 500 can include one or more order widgets 510A-N and/or a sub search option 515. Each of the one or more order widgets 510A-N can organize the assets 505A-N based on one or more criteria such as, for example, each asset's address, owner, owner type, property group, municipality code, sale date, sale amount, and/or any other asset attribute corresponding to the assets 505A-N. The sub search option 515 can enable the user to input search criteria for filtering the one or more user assets 505A-N. In this manner, the user profile interface 500 can enable a user to search for one or more assets within the one or more user assets 505A-N.

In addition, the user profile interface 500 may include one or more interactive widgets 530. Each of the interactive widgets 530 can enable the user to interact with a specific asset, such as asset 505A. As an example, the interactive widgets 530 can include a viewing widget such as an interactive button. The user can provide user input to the viewing widget to instruct the asset management system 150 to present an asset profile for a respective asset. As another example, the interactive widgets 530 can include an editing widget, such as an interactive button. The user can provide user input to the editing widget to instruct the asset management system 150 to present an editable asset profile for a respective asset 505. The user can interact with the editable asset profile to add, modify, and delete one or more attributes of the asset profile.

The interactive widgets 530 of the user profile interface 500 can include a deletion widget, such as an interactive button. The user can provide user input to the deletion widget to instruct the asset management system 150 to remove the respective asset from the one or more user assets 505A-N. Moreover, in some implementations, the interactive widgets 530 can include an integration and/or transfer widget (e.g., an interactive button). The user can provide user input to the integration and/or transfer widget to instruct the asset management system 150 to generate a client letter by integrating asset information (e.g., from the asset profile and the holistic cost segregation) to a customer letter or generate a transferable file such as an excel file representative of the asset information such that the asset information can be imported to one or more other applications (e.g., Salesforce).

The user profile interface 500 can include any number of additional interactive widgets 530. For example, the interactive widgets 530 could include a mapping widget configured to present an interactive map centered around the respective asset, and/or any other interactive widget that may enable a user to interact with a respective asset. In some implementations, the user can be associated with one or more user permissions. In such a case, each of the interactive widgets can be available to the user based at least in part on the user's user permissions. As an example, a user with administration permissions can be able to delete an asset from a commercial user profile, whereas a user without admin permissions is restricted from adding an asset to a commercial user profile.

Turning back to FIG. 1, the estimation system 170 of the asset management system 150 is configured to automatically generate a holistic cost segregation estimate for a selected asset 165 in response to one or more user inputs. The holistic cost segregation estimate can include depreciation data, benefit data, and/or segregation schedule data. In some implementations, the estimation system 170 can implement one or more processes or subroutines to generate components of the cost segregation estimate. For example, the estimation system 170 can include a depreciation system 175 configured to generate depreciation data, a benefit system 176 configured to generate benefit data (e.g., catch up depreciation), and/or a scheduling system 177 configured to generate segregation schedule data (e.g., one or more cost segregation schedule(s).

The holistic cost segregation estimate can be generated based, at least in part, on historical cost segregation data of the historical database 130 and/or a respective asset profile 135 corresponding to selected asset 165. For example, the estimation system 170 can obtain and/or generate an asset profile for the selected asset 165. In some implementations, the asset database 130 can include an asset profile for each asset of the asset database 130. In this instance, each asset profile 135 can be predetermined for an asset at the time and/or before the asset is added to the asset database 130.

Preferably, the asset profile 135 can be determined in real time. For instance, the asset management system 150 can access the asset database 130 and/or the historical database 140 to obtain one or more asset attributes corresponding to the selected asset 165 and/or historical cost segregation data corresponding to the selected asset 165. The asset management system 150 can generate the asset profile for the selected asset 165 based on the one or more asset attributes and/or the historical cost segregation data. By way of example, the asset profile can include one or more verified asset attributes corresponding to the selected asset 165 and/or one or more historical cost segregation studies. As noted, historical cost segregation studies may include cost segregation estimates, depreciation data, benefit data, and segregation schedule data.

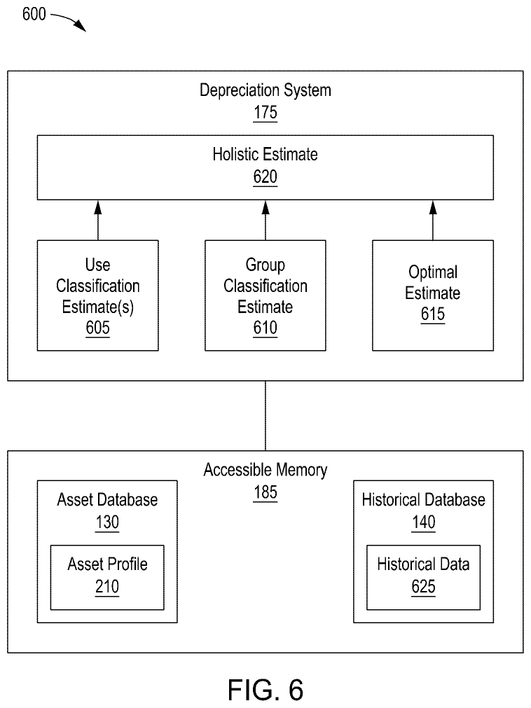

FIG. 6 presents a data flow diagram 600 for generating depreciation data. The depreciation system 175 can determine holistic depreciation data based on the asset profile 210 corresponding to the selected asset and historical cost segregation data 625 of the historical database 140. The holistic depreciation data, shown as holistic estimate data 620, can include, for example, a five year depreciation average and/or a fifteen year depreciation average for a selected asset. The depreciation system 175 can generate the holistic depreciation data based on at least one of the use depreciation data (shown as estimate 605), group depreciation data (shown as estimate 610), and/or optimal depreciation data (shown as estimate 615).

By way of example, the depreciation system 175 can obtain one or more asset attributes from the asset profile 210 such as, for example, an asset identifier, a use classification, an address state, a last sale date, a last sale price, a building size and/or a lot size. In addition, the depreciation system 175 can obtain (via the asset profile 210 and/or one or more other sets of data based on the asset identifier) a tax market value total and/or a tax assessed value total.

FIG. 6 shows an enlarged version of the accessible computer memory 185. The asset database 130 and the historical database 140 are separately shown. The asset database 130 holds asset attributes of the asset profile 210. Such asset attributes may include one or more use classifications. In such a case, the depreciation system 175 can determine use depreciation data (e.g., use classification estimate(s) 605) for the selected asset based, at least in part, on the use classification(s). The historical database 140 includes historical data 625 representing any historical cost segregation studies for the assets. The historical cost segregation studies can be previously generated studies for one or more respective assets of the asset database 130 that include a use classification matching a respective use classification of the selected asset.

The depreciation system 175 can aggregate the historical cost segregation studies estimates to determine a use classification estimate for the respective use classification. This process can be repeated for each use classification corresponding to the selected asset. The resulting use classification estimate 605 can include a use classification five year estimate indicative of the average five year depreciation percentage for the one or more respective assets and/or a use classification fifteen year estimate indicative of an average fifteen year depreciation percentage for the one or more respective assets.

The holistic cost segregation estimate 620 can be generated based, at least in part, on the use depreciation data (e.g., estimate 605). For instance, a use classification estimate of the use classification estimate(s) 605 can be selected for use based on one or more factors. The selected use classification estimate can be used to generate the holistic cost segregation estimate 620. In addition, or alternatively, a holistic cost segregation estimate 620 can be generated for each different use classification estimate generated for the selected asset.

The asset profile 210 can include an asset group classification. The group classification can be determined based on the use classification estimate(s) 605.

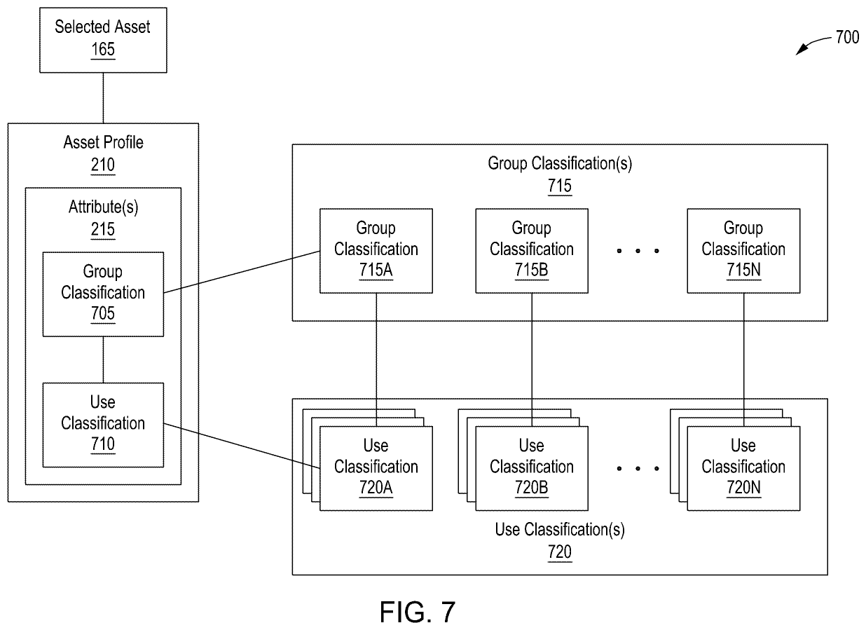

FIG. 7 depicts an example relationship 700 between attributes of an example asset profile. As depicted, the selected asset 165 can be associated with an asset profile 210 with one or more attributes 215. The attributes 215 can include a use classification 710 and/or an asset group classification 705. The asset group classification 705 can identify a respective asset group (e.g., 715A) of a plurality of predefined asset groups 715.

The asset group classification 705 may include one of a plurality of group classifications 715. The plurality of group classifications 715 can include a plurality of predefined group classifications 715A-N. Each respective group classification 715 can be indicative of an association between one or more use classifications 720A-N. The group classifications 715A-N can separate a larger number of use classifications 720A-N into larger pools of similarity. For instance, group classification(s) 715 can be created to group over three-hundred and sixty-six standardized asset use classifications 720 into groups 720A-N that reflect the type and amount of five and fifteen year property an asset typically has. By way of example, each group classification of the group classification(s) 715 can link a plurality of use classifications 720 (e.g., municipality codes and/or other standardized codes or categories for a property) based on similar historical cost segregation information such as, for example, similar depreciate data associated with assets classified by the plurality of use classifications.

By way of example, a property group classification 715A-N can include retail, industrial, restaurant, warehouse, residential, office, gas station, commercial condominium, mix use, medical, parking garage, hotel, car wash, manufacturing, recreation, car dealership, golf course, residential condominium, commercial miscellaneous, or multi-family classifications. Each group classification (e.g., 715A) can identify a similarity between a plurality of use classifications (e.g., 720A). As one example, a group classification of retail can include one or more different use classifications such as shopping malls and clothing outlets. In addition, a group classification of car wash can include one or more different State specific use classifications used to identify car washes across one or more different States. In some implementations, the computing systems described herein can validate a use classification assigned to an asset by an external source (e.g., a municipality code assigned by a county reporter or a tax assessor collector) based on the group classification and/or one or more historical cost segregation studies.

The asset management system 150 can obtain a previously determined asset group classification 705 from the asset profile 210. For example, generating the asset profile 210 can include determining the asset group classification 705 for the selected asset 165 based, at least in part, on the one or more asset attributes 215 (e.g., use classification 710) corresponding to the selected asset 165. In addition, the asset management system 150 can determine asset group classification 705 in real time after the selection of the selected asset 165. For example, the asset management system 150 can access a relationship table identifying one or more relationships between one or more predefined group classification(s) 715A-N and one or more sets of use classifications 720A-N. The asset management system 150 can compare the use classification 710 of the selected asset 165 to the relationship table to determine the group asset classification 705. In the event, the relationship table does not specify a relationship between the use classification 710 and at least one group asset classification 715A-N, the asset management system 150 can assign a default value (e.g., commercial miscellaneous) to the group asset classification 705.

Turning back to FIG. 6, the depreciation system 175 can determine group depreciation data via group classification estimate 610 for a selected asset. This may be based on the asset group classification assigned to the selected asset and the historical cost segregation data 625. The depreciation system 175 can identify one or more historical cost segregation studies from historical cost segregation data 625 that correspond to one or more assets associated with the group classification. For instance, the one or more historical cost segregation studies can be previously performed for one or more respective assets of the asset database 130 that include a group asset classification matching the group asset classification of the selected asset. The depreciation system 175 can aggregate the one or more historical cost segregation studies and/or estimates to determine a group classification estimate 610.

The group classification estimate 610 can include a group classification five year estimate indicative of the average five year depreciation percentage for the one or more respective assets and/or a group classification fifteen year estimate indicative of an average fifteen year depreciation percentage for the one or more respective assets. The depreciation system 175 can generate the holistic cost segregation estimate 620 based, at least in part, on the group depreciation data (e.g., estimate 610).

In one aspect, the depreciation system 175 can obtain a last sale date for a selected asset. If the asset profile 210 includes a last sale data attribute, the depreciation system 175 can set a temporary place in service date attribute to the value of the last sale date attribute. Alternatively, the depreciation system 175 can set the temporary place in service date attribute to the most recent instrument date associated with the selected asset from the asset data. As another example, the depreciation system 175 can obtain a purchase price from the asset profile. For instance, the depreciation system 175 can assign a value to a temporary purchase price attribute for the selected asset based on the higher value between a last sale amount attribute indicative of the sale price for the asset at the last sale, a tax market value total attribute indicative of tax value of the asset, and/or a tax assessed value total attribute indicative of the assessed tax value of the selected asset.

The depreciation system 175 can obtain system configuration parameters. The system configuration parameters can include a federal tax rate, a mid-quarter convention, a leasehold value indicating whether the selected asset is a lease hold, and/or a net present discount factor. In addition, the system configuration parameters can include a state tax rate (e.g., obtained based on a location attribute of the asset profile 210), a bonus depreciation value (e.g., obtained based on the place in service date), and/or a residential flag value indicating whether the asset group classification is residential.

The depreciation system 175 can utilize one or more of the asset attributes from the asset profile 210 and/or the one or more temporary asset attributes to determine optimal depreciation data 615. As an example, the one or more asset attributes from the asset profile 210 can include a purchase price and an asset footprint indicative of at least one of a building size and/or a lot size. The depreciation system 175 can determine an optimal asset for the selected asset based, at least in part, on the asset profile 210 and/or the one or more asset attributes. The optimal asset can include the most similar asset from a subset of assets of the asset database 130 that is associated with a cost segregation study and/or estimate of the historical cost segregation data 625. The subset of assets, for example, can include a use subset of assets including each of the assets of the asset database 130 associated with a use classification matching the use classification of the selected asset. In addition, or alternatively, for example, in the event the use subset of assets does not include any asset associated with a cost segregation study and/or estimate from the historical database, the subset of assets can include a group subset of asset including each of the assets of the asset database 130 associated with an asset group classification matching the asset group classification of the selected asset.

The depreciation system 175 can determine a similarity value for each of the subsets of assets (e.g., the use subset, the group subset, etc.) of the asset database 130 based, at least in part, on a comparison between the purchase price and/or the asset footprint (e.g., building size and/or lot size) corresponding to the selected asset and a respective purchase price or asset footprint (e.g., building size and/or lot size) corresponding to each respective asset of subset of assets. The depreciation system 175 can determine the optimal asset from the subset of assets based, at least in part, on a similarity value for each of the subset of assets.

The depreciation system 175 can search the asset database 130 and the historical database 140 for at least two assets with similar purchase prices to the selected asset. For instance, the at least two assets can include one asset (and/or study (e.g., real and/or estimated cost segregation analysis) associated with the asset) with the closest lower purchase price to the purchase price of the selected asset and another asset (and/or study (e.g., real and/or estimated cost segregation analysis) associated with the asset) with the closest higher purchase price to the purchase price of the selected asset. The optimal asset can be determined from the at least two assets. For instance, the optimal asset can include the asset associated with the closest building size to the building size of the selected asset. In addition, or alternatively, the optimal asset can include the asset with the closest lot size to the lot size of the selected asset. In some implementations, for example, in the event the asset profile 210 does not include a building size attribute or a lot size attribute, the optimal asset can include the asset with the closest purchase price to the purchase price of the selected asset.

The depreciation system 175 can determine optimal depreciation data 615 corresponding to the optimal asset. The optimal estimate 615 can include an optimal five year estimate indicative of the five year depreciation percentage for the optimal asset and/or an optimal fifteen year estimate indicative of the fifteen year depreciation percentage for the optimal asset. The depreciation system 175 can generate the holistic cost segregation estimate 620 based, at least in part, on the optimal depreciation data 615. For example, the depreciation system 175 can determine the holistic depreciation data 620 based on the use depreciation data 605, the group depreciation data 610, and the optimal depreciation data 615.

In the event that the asset profile 210 includes a use classification and a group classification and the subset of assets associated with the use classification include one or more assets associated with one or more cost segregation studies and/or estimates from the historical database 140, the depreciation system 175 can determine the holistic depreciation data 620 based on an average of the use depreciation data 605, the group depreciation data 610, and the optimal depreciation data 615.

In the event that the asset profile 210 includes at least a group classification and the subset of assets associated with the group classification include one or more assets associated with one or more cost segregation studies and/or estimates from the historical database 140, the depreciation system 175 can determine the holistic depreciation data 620 based on an average of the group depreciation data 610, and the optimal depreciation data 615. In the event that the subset of assets associated with the group classification and the use classification do not include at least one asset associated with a cost segregation study and/or estimate from the historical database 140, the holistic depreciation data 620 can include the group depreciation data 610.

Turning back to FIG. 1, the estimation system 170 of the asset management system 150 may be programmed to determine a cost segregation estimate. The cost segregation estimate can be indicative of a five year depreciation estimate and/or a fifteen year depreciation estimate for a selected asset 165. The asset management system 150 can determine a depreciation schedule using the scheduling system 177, and a benefit analysis using the benefit system 176.

The depreciation schedule and the benefit analysis can be determined based, at least in part, on the holistic depreciation estimate 620. For example, the scheduling system 177 can determine one or more depreciation schedules for the selected asset 165 based, at least in part, on the holistic depreciation data, a residential flag value (e.g., data indicative of whether the selected asset 165 is a residential property or a commercial property), and/or one or more other system configuration parameters (e.g., mid-quarter convention, State tax rate, and bonus depreciation value).

The scheduling system 177 can determine a default depreciation period in years based on the residential flag value. The default depreciation period in years can include twenty-seven and a half years in the event that the residential flag value for the selected asset 165 is indicative of a residential property. Otherwise, the default depreciation period in years can include thirty-nine years. The scheduling system 177 can determine a five year depreciation schedule (e.g., with a depreciation period in years of five), a fifteen year depreciation schedule (e.g., with a depreciation period in years of fifteen), and/or a default depreciation schedule (e.g., with a depreciation period in years of 27½ or 39).

To do so, the scheduling system 177 can determine a depreciation rate for each of the depreciation schedules. For instance, the five year depreciation schedule rate can be 2/the depreciation period in years (e.g., 5). The fifteen year depreciation schedule rate can be 3/2*the depreciation period in years (e.g., 15). And, the default depreciation schedule can be 1/the depreciation period in years (e.g., 27½ or 39).

The scheduling system 177 can determine a first year portion for the five year and fifteen year depreciation schedules based on the place−in service date. For instance, the first year portion of the five year depreciation schedule can be 0.5 in the event that the mid quarter convention if false and the month of the place in service date is between January and September. The first year portion of the five year depreciation schedule can be 0.25 in the event that the mid quarter convention is false and the place in service date is between October and December. In addition, or alternatively, the first year portion of the fifteen year depreciation schedule can be 0.375 in the event that the mid quarter convention if false and the month of the place in service date is between January and September and 0.125 in the event that the mid quarter convention is false and the place in service date is between October and December. The first year portion of the default depreciation schedule can be: (25−(2*Month Number of the Place in Service Data))/24.

The scheduling system 177 can determine a first year depreciation percentage for each of the depreciation schedules. For instance, if the bonus depreciation is 50%, the respective first year percentage (e.g., first year percentage of the five year depreciation schedule or the first year percentage of the fifteen year depreciation schedule) can be 50%+(50%*respective depreciation rate*respective first year portion of the respective depreciation schedule (e.g., five year or fifteen year)). The respective first year percentage for the default depreciation schedule can be the depreciation rate*the first year portion. The first year cumulative depreciation percentage for each of the depreciation schedules can be the respective first year percentage.

The scheduling system 177 can determine a yearly depreciation percentage for each year of each of the depreciation schedules (e.g., five years for the five year depreciation schedule, fifteen years for the fifteen year depreciation schedule, period in years (e.g., 27½, 39) for the default depreciation schedule). To do so, the scheduling system 177 can determine a percentage remaining by subtracting the cumulative percentage for the previous year from 100%. For example, the second year's percentage remaining can include 100%−the respective first year percentage of a respective depreciation schedule. The third year percentage remaining can include 100%−the respective first year percentage and the respective second year percentage for the respective depreciation schedules.

For each year of each respective depreciation schedule, the scheduling system 177 can determine a respective yearly depreciation rate. For instance, the five year depreciation schedule yearly depreciation rate of a respective year can be the max value between 2/the depreciation period in years (e.g., 5) and 1/(the depreciation period in years (e.g., 5)−the first year portion+2−the respective year). The fifteen year depreciation schedule yearly depreciation rate for a respective year can be the max value between 3/(2*the depreciation period in years (e.g., 15)) and 1/(the depreciation period in years (e.g., 15)−the first year portion+2−the respective year). The default depreciation schedule yearly depreciation rate of a respective year can be 1/(depreciation period in years (e.g., 27½, 39, etc.)+2−the respective year).

The scheduling system 177 can determine a yearly portion for each respective year of each of the depreciation schedules. The yearly portion for a respective year can be the depreciation period of years (e.g., 5, 15, 27½, 39, etc.)−the first year portion+2−the respective year. If the yearly portion for the respective year is less than zero it can be set to zero. If the yearly portion for the respective year is greater than one it can be set to 1. The scheduling system 177 can determine a depreciation percentage for the respective year by multiplying the percentage remaining for the respective year with the yearly depreciation rate and the yearly portion of the respective year (e.g., percentage remaining*yearly depreciation rate for the respective year*yearly portion for the respective year). The cumulative percentage for the respective year can be the cumulative sum of the first year depreciation rate and each yearly depreciation rate for each year preceding the respective year. The scheduling system 177 can determine a depreciation rate for each year of each of the depreciation schedules.

The scheduling system 177 can generate one or more depreciation schedules for a selected asset 165, with each depreciation schedule identifying a depreciation percentage for the selected asset 165 for each year of the depreciation schedule. In some implementations, the holistic cost segregation estimate 620 can include one or more of the cost segregation schedules. The cost segregation schedules may optionally be utilized to generate a benefit analysis for the selected asset 165.

The benefit system 176 of the asset management system 150 can generate a benefit analysis for a selected asset 165 based on a place-in-service date, a purchase price, a holistic depreciation estimate 175 (e.g., average five year depreciation percentage or average fifteen year depreciation percentage), a leasehold value, and/or the depreciation schedules. To do so, the benefit system 176 determines a new average five year depreciation percentage and a new fifteen year depreciation percentage for the selected asset 165. The new five year average depreciation percentage can be the average five year depreciation percentage minus 0.02. In the event that the selected asset 165 is a leasehold (e.g., as indicated by the leasehold value), the new fifteen year average depreciation percentage can be 1−the new five year average depreciation percentage. In the event that the selected asset 165 is not a leasehold (e.g., as indicated by the leasehold value), the new fifteen year average depreciation percentage can be the average fifteen year depreciation percentage minus 0.02.

The benefit system 176 can determine a five year depreciable basis, a fifteen year depreciable basis, and a default depreciable basis for the selected asset 165. The five year depreciable basis can be the new five year average depreciation percentage*the purchase price of the selected asset 165. The fifteen year depreciable basis can be the new fifteen year average depreciation percentage*the purchase price of the selected asset 165. And, the default depreciable basis can be the purchase price−the five year average depreciable basis−the fifteen year average depreciable basis.

The benefit system 176 can generate a benefit analysis for the selected asset 165 for 40 years after the place-in-service year of a selected asset 165. The benefit analysis can include a five year depreciation, a fifteen year depreciation, a depreciation default, a total depreciation after a cost segregation analysis, a total depreciation without a cost segregation analysis, and a timing benefit for utilizing a cost segregation analysis. The five year depreciation (e.g., an amount depreciated over five years) can be the five year depreciable basis*the depreciation rate for a respective year of the five year depreciation schedule (e.g., from the five year depreciation schedule). The fifteen year depreciation (e.g., an amount depreciated over fifteen years) can be the fifteen year depreciable basis*the depreciation rate for a respective year of the fifteen year depreciation schedule (e.g., from the fifteen year depreciation schedule). The default depreciation (e.g., a default amount depreciated over the period in years) can be the default depreciable basis*the depreciation rate for a respective year of the default depreciation schedule (e.g., from the default depreciation schedule).

The benefit system 176 can determine the total depreciation after the cost segregation analysis for a respective year by adding the five year depreciation, the fifteen year depreciation, and the default depreciation for the respective year. The benefit system 176 can determine the total depreciation without the cost segregation analysis by multiplying the purchase price by the depreciation rate for a respective year of the default depreciation schedule (e.g., from the default depreciation schedule). The benefit system 176 can determine the yearly timing benefit for utilizing a cost segregation analysis by subtracting the total depreciation without the cost segregation analysis from the total depreciation after the cost segregation analysis for a respective year. The benefit system 176 can determine a cumulative benefit by aggregating (e.g., adding) the yearly timing benefit for each respective year for 40 years.

The asset management system 150 can determine a first year depreciation difference for the selected asset 165 based, at least in part, on the benefit analysis that corresponds to the place-in-service date year for the selected asset 165. The asset management system 150 can determine an estimated first year cash benefit for the selected asset by multiplying the first year depreciation difference with an estimated marginal tax rate (e.g., the Federal tax rate+State tax rate) for the selected asset 165.

The asset management system 150 can determine the accumulated five year cash benefit for the selected asset 165. To do so, the asset management system 150 can determine a net profit value (“NPV”) for the years 2-5. The second year net profit value, for example, can be: 1/(1+the NPV discount factor). The third year net profit value can be: second year NPV/1+NPV discount factor). The fourth year net profit value can be: third year NPV/1+NPV discount factor). And, the fifth year net profit value can be: fourth year NPV/1+NPV discount factor). The asset management system 150 can determine the year benefit by multiplying each respective year's net profit value with the corresponding timing difference from the benefit analysis. The accumulated five year cash benefit for the selected asset 165 can be the sum of all first five year benefits.

The asset management system 150 can store the holistic cost segregation estimate 620 and/or one or more components thereof (e.g., the holistic depreciation data, the one or more cost segregation schedules, the benefit analysis, and the accumulated five year benefit) for a selected asset 165 in the historical database 140. By doing so, the holistic cost segregation estimates generated by the asset management system 150 can be used to determine subsequent cost segregation estimates. In this manner, the asset management system 150 can generate more robust and accurate cost segregation estimates over time. In some implementations, the stored cost segregation estimates can be verified by a cost segregation study (e.g., a real cost segregation study performed for the respective asset). In such a case, the asset management system can prioritize verified cost segregation estimates over unverified cost segregation estimates while generating a new cost segregation estimate. This may be done, for example, through a weighting scheme.

The asset management system 150 can provide for display to a user of a holistic cost segregation estimate 620 and components thereof. These may include, for example, a holistic depreciation estimate 175, a benefit analysis 176, and one or more cost segregation schedules to the user 105. By way of example, in response to the user input, the asset management system 150 can provide to the user 105 a user interface presenting the asset profile 135, and a holistic cost segregation estimate for the selected asset 165. The cost segregation estimate can be calculated automatically when the selected asset 165 (e.g., a real estate property) is added to a personal and/or commercial user profile and/or identified in any other manner. Thereafter, that the user 105 has the ability to generate new estimates and/or delete existing estimates for the select asset 165.

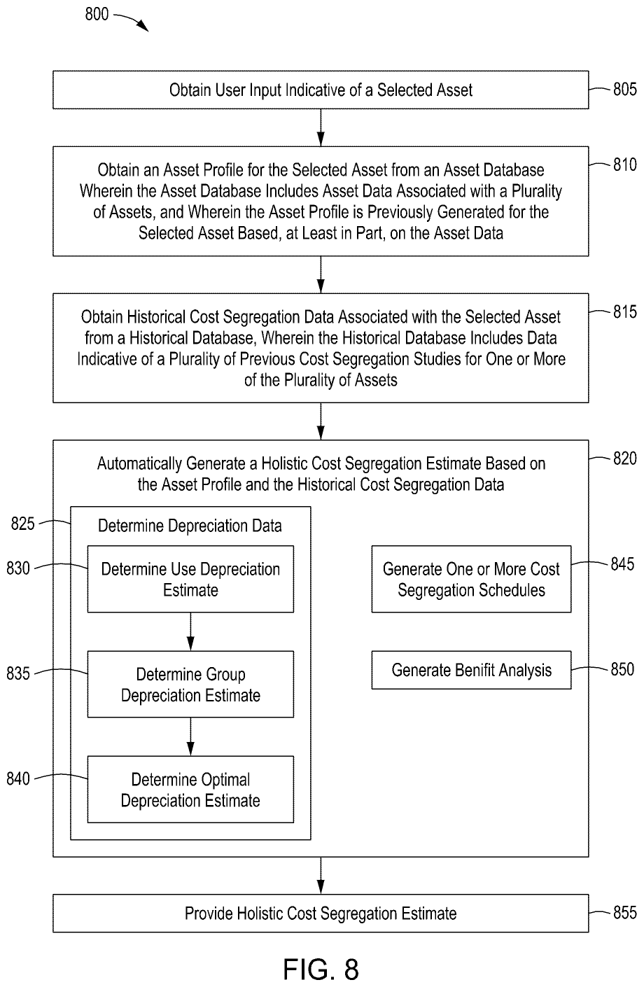

FIG. 8 presents a flow chart for a method 800 of generating a cost segregation estimate, in one embodiment. The method 800 can be implemented, for instance, a computing device 105 along with the asset management system 150 as described above in any of its embodiments. Portions of the method 800 may be implemented as an algorithm on the hardware components of the devices described herein to, for example, automatically generate and display cost segregation analysis.

FIG. 8 depicts steps performed in a particular order for purposes of illustration and discussion. Those of ordinary skill in the art, using the disclosure provided herein, will understand that various steps can be omitted, expanded to include other steps, performed simultaneously, rearranged, and/or modified in various ways without deviating from the scope of the present disclosure.

The method 800 first includes the step of obtaining user input indicative of a selected asset. This is shown in Box 805. The step of Box 805 may include a user using a computing system to display a first user interface presenting one or more of a plurality of assets for selection by the user. The selection user input can be indicative of a selected asset from the one or more presented assets.

In one aspect, the computing system can display to the user a preceding user interface (e.g., a user interface preceding the selection user input) presenting one or more search criteria options. The computing system can obtain, via the preceding user interface, query user input indicative of search criteria for the one or more of the plurality of assets. The search criteria can be indicative of one or more asset attributes. In such a case, the computing system can identify the one or more of the plurality of assets based, at least in part, on the search criteria selected by the user. The one or more of the plurality of assets, for example, can be associated with the one or more asset attributes. The search criteria, for example, can include at least one of location data, ownership data, price data, a group classification, a use classification, a footprint, and/or depreciation data.

In some implementations, the computing system can provide for display to the user a subsequent user interface (e.g., a user interface subsequent to the selection user input) presenting one or more user profile options for selection by the user. The computing system can obtain, via the subsequent user interface, user profile input indicative of a user profile option. The user profile option can be indicative of adding the selected asset to a user profile.

The method 800 next comprises the step of obtaining an asset profile for the selected asset from an asset database, wherein the asset database includes asset data associated with a plurality of assets, and wherein the asset profile is previously generated for the selected asset based on the asset data. This is seen in Box 810. For instance, the asset management system 150 can obtain an asset profile for a selected asset from an asset database. The asset database can include asset data associated with a plurality of assets. The asset profile can be previously generated for the selected asset based on the asset data.

The asset profile can include one or more asset attributes corresponding to the selected asset. As an example, the asset profile can include one or more asset attributes indicative of at least one of the location data, ownership data, price data, group classification, use classification, footprint, and/or depreciation data. For instance, the asset data corresponding the selected asset can include a plurality of asset attributes corresponding the selected asset. Previously generating the asset profile for the selected asset can include assigning a confidence score to each of the plurality of asset attributes corresponding to the selected asset and generating the asset profile for the selected asset based on the confidence score for each of the plurality of asset attributes corresponding to the selected asset. For example, the asset profile for the selected asset can include one or more asset attributes associated with a respective confidence score above a confidence threshold.

The method 800 next includes obtaining historical cost segregation data associated with the selected asset from a historical database, wherein the historical database includes data indicative of a plurality of previous cost segregation studies for one or more of the plurality of assets. This is provided in Box 815. In this step, the asset management system 150 obtains the historical cost segregation data associated with the selected asset from the historical database. The historical cost segregation database can include data indicative of a plurality of previous cost segregation studies for one or more of the plurality of assets.

The method 800 next comprises automatically generating a holistic cost segregation estimate for the selected asset based on the asset profile and the historical cost segregation data. This is indicated at Box 820. In this step, the asset management system 150 automatically generates a holistic cost segregation estimate for the selected asset based on the asset profile and the historical cost segregation data. The holistic cost segregation estimate can include holistic depreciation data, one or more cost segregation schedules, and/or a benefit analysis for the selected asset. The computing system can automatically generate the holistic cost segregation estimate for the selected asset in response to the selection user input and/or the user profile user input.

The method 800 additionally includes determining the holistic depreciation data. This is shown at Box 825. In this step, the asset management system 150 is used to generate the holistic depreciation data. The holistic depreciation data can be an average of at least one of use depreciation data, a group depreciation data, and/or an optimal depreciation data. For instance, the computing system can determine the holistic deprecation data based, at least in part, on the average of the use depreciation data, the group depreciation data, and the optimal depreciation data. The holistic depreciation data can include a five year depreciation average and a fifteen year depreciation average for the selected asset.

The method 800 further comprises determining use depreciation data. This is seen at Box 830. In this step, the one or more asset attributes can include a use classification. The computing system can determine the use depreciation data for an asset based, at least in part, on the use classification along with the associated historical cost segregation data. Beneficially, the asset management system 150 can generate the holistic cost segregation estimate based, at least in part, on the use depreciation data.

The method 800 also includes determining group depreciation data. This is provided at Box 835. In this step, the attributes of the asset profile can include an asset group classification. Previously generating the asset profile for the selected asset can include determining the asset group classification for the selected asset based on the one or more asset attributes corresponding to the selected asset. The asset group classification can identify a respective asset group of a plurality of predefined asset groups. Each of the plurality of predefined asset groups can be indicative of an association between one or more use classifications. The computing system can determine the group depreciation data for the asset based on the asset group classification and the historical cost segregation data. The computing system can generate the holistic cost segregation estimate based on the group depreciation data.

The method 800 also comprises determining optimal depreciation data. This is seen at Box 840. In this step, the computing system can determine an optimal asset for the selected asset based, at least in part, on the asset profile. The computing system can determine the optimal depreciation data corresponding to the optimal asset. And, the computing system can generate the holistic cost segregation estimate based, at least in part, on the optimal depreciation data.

By way of example, the one or more asset attributes can include a purchase price and an asset footprint indicative of at least one of a building size or a lot size. The asset management system 150 can determine a similarity value for each of a subset of assets of the asset database based, at least in part, on a comparison between the purchase price or the asset footprint corresponding to the selected asset and a respective purchase price or asset footprint corresponding to each respective asset of subset of assets. The asset management system 150 can determine the optimal asset from the subset of assets based, at least in part, on the similarity value for each of the subset of assets.

The method 800 further includes generating one or more cost segregation schedules and a benefit analysis. These steps are shown at Boxes 845 and 850. In support of these steps, the asset management system 150 generates cost segregation schedules based, at least in part, on the holistic depreciation data. The asset management system 150 then generates the benefit analysis based, at least in part, on the one or more cost segregation schedules.

The method 800 finally comprises providing the holistic cost segregation estimate to the user. This is indicated at Box 855. In this step, the asset management system 150 provides the holistic cost segregation estimate to the user. By way of example, the computing system can provide for display to the user a user interface presenting at least one of the asset profile and/or the holistic cost segregation estimate for a selected asset. The computing system can provide the user interface in response to the selection user input and/or the user profile input. In some implementations, the user interface can further present at least one of a respective asset profile or a respective holistic cost segregation estimate for the selected asset and each of a plurality of previously selected assets.

In addition, or alternatively, the computing system can store, in an accessible memory, data indicative of the asset and the cost segregation estimate. For example, the computing system can store the holistic cost segregation estimate in the historical database.

As can be seen, the asset profile of the disclosed technology allows for more flexible and nuanced cost segregation analysis by enabling the generation of accurate estimates without visualizing the selected asset. Moreover, the cost segregation estimates can be stored (and later used) in a historical database. In this way, the computing system can increase the accuracy of estimates over time based, at least in part, on estimates generated by the system (e.g., using one or more learning techniques).

It is noted that a cost segregation estimate as discussed in the method 800 is not the same thing as a cost segregation study. An estimate can be provided to a property owner or to the property owner's CPA for initial discussion, but is not suitable for submission to the Internal Revenue Service as a basis for depreciation. To obtain the benefit of a cost segregation depreciation, a cost segregation study must be conducted.

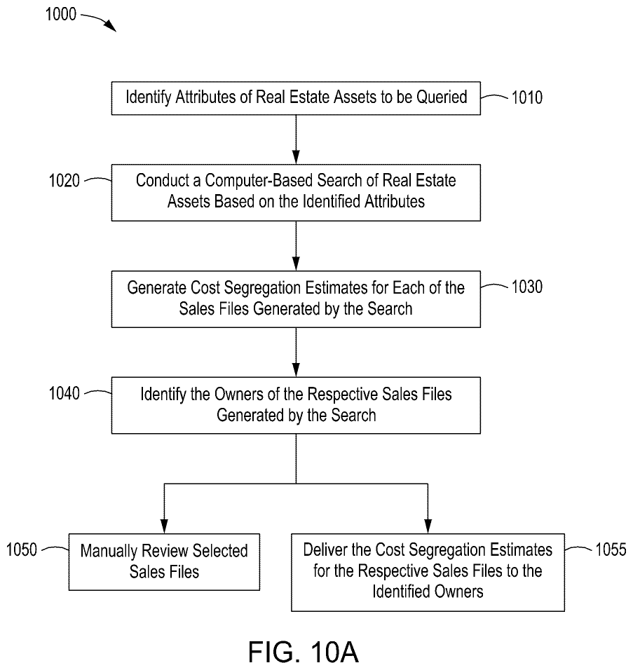

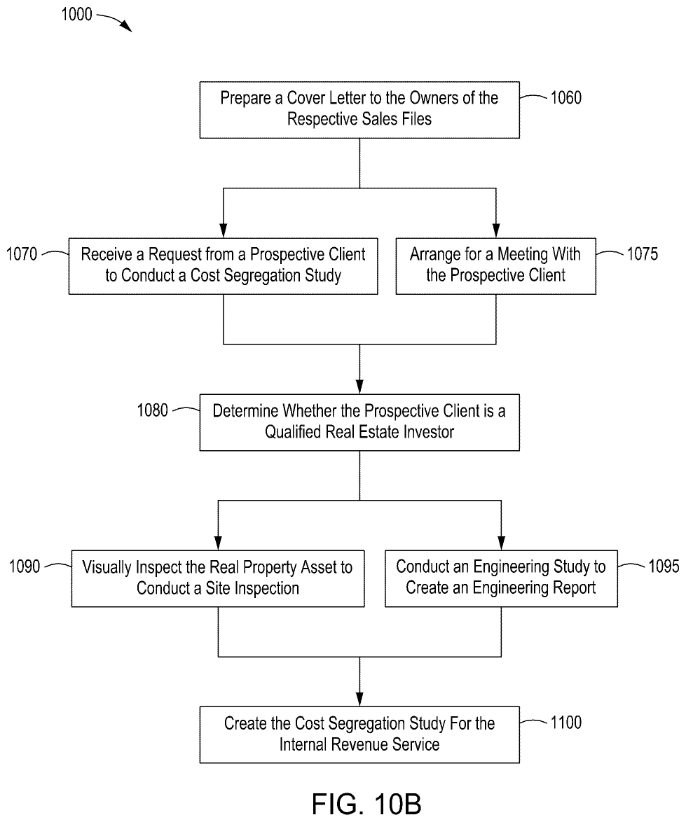

FIGS. 10A and 10B together present a flow chart for a method 1000 of generating a cost segregation study. The method 1000 first includes the step of identifying asset attributes to be queried. This is shown in Box 1010, seen in FIG. 10A. For example, attributes might include all real estate sales conducted in the State of South Carolina since Jul. 1, 2019. An attribute might further include all of such sales valued between $2,000,000 and $12 million.

The purpose of the step of Box 1010 is to generate sales files for a marketing campaign. Thus, after the attributes are selected, the user will conduct a search based on the attributes. This is shown at Box 1020. The search is a computer-based search such as may be in accordance with the step of Boxes 810 and 815 described above. In the search of Box 1020, a plurality of real estate assets are generated, referred to as sales files or “CRM files.”

In one example, the search of Box 1020 for South Carolina properties might generate sales files for 5,000 properties. Thus, the user has 5,000 potential customers for a cost segregation study.

A next step in the method 1000 may be to generate cost segregation estimates for each of the sales files generated from the search of Box 1020. This is seen in Box 1030. The step of Box 1030 may be in accordance with the step of Box 820 (and its component Boxes 825, 830, 835, 840, 845, 850) described above. In this case, 5,000 cost segregation estimates 855 are generated.

It is observed that when a cost segregation study is performed, the user is allocating a certain percentage of the real estate asset to a five-year property basis and a certain percentage to a 15-year property basis. This is part of the Box 825 reference, and involves a manual determination.

Those of ordinary skill in the art will understand that a five-year property is anything fixed to the building and that is used for the sake of doing business. This portion of the asset can be removed without harming or diminishing the value of the structure. A classic example is a storage shed or a generator. A fifteen-year property represents any land improvements like he curbing of parking lots or signs that are installed for the sake of doing business or add-ons to a structure. The user will need to allocate 5- and 15-year property percentages to generate accurate cost segregation estimates.

By analyzing the historical database, or the results from the historical database of studies 140, the user can go into the asset management system 150 and manually put in how much of each study was allocated to 5-year property and how much of each study was allocated to 15-year property. In addition, the user can manually identify what the property group 705 was and what the property type, or classification 710, was.

The allocation of percentages may be within the software configuration, but requires a manual input. The average percentages are transferred into their correct spots for the next step that the software does, so the software takes those averages and then analyzes the properties to produce an estimate under Box 820. The initial averages of the results are manually input.

The method 1000 may next include identifying the owners of the respective sales files from the search of Box 1020. This is provided in Box 1040.

The method 1000 then comprises delivering the cost segregation estimates for the respective sales files to the corresponding owners identified in the step of Box 1040. This is seen in Box 1055. The “delivering” step may comprise e-mailing, mailing through the U.S. Postal Service, or using a for-profit courier delivery service such as FedEx® of Memphis, Tennessee.

Optionally, the user may manually review one, one or more, or even all of the sales files before the delivery step of Box 1050 is performed. This is shown in box 1050.

Optionally, the user may prepare a cover letter to be sent to each of the owners of the respective sales files. These would go with the cost segregation estimates. The step of preparing a cover letter is provided in Box 1060, seen in FIG. 10B. The cover letter will have contact information for the user, meaning that a property owner, as a prospective cost segregation customer, may contact the user for cost segregation services.

A plurality of sales files generated from the search 1020 along with the cost segregation estimates 1030 (or 620) and the cover letters 1050 may be referred to as a marketing campaign. Beneficially, a marketing campaign may be stored and later displayed to the user, such as in display 500. The user can manually input contact events to display 500, or make manual changes to selected estimates 620.

The asset management system 150 may provide a user interface that enables the creation of a single file for the marketing campaign. Thus, instead of clicking each property (or sales file) individually, the user may press (manually or by using a mouse or pointer) a button indicative of a .pdf file. A single .pdf file is then downloaded and is available, if needed, for printing.

Similarly, the asset management system 150 may provide a user interface that enables the user to print the raw variable data. This may include the owner's company name, its property address, the numbers for the benefit analysis, the cost segregation estimate, and then the mailing address data. Thus, instead of clicking each property (or sales file) individually, the user may press (manually or by using a mouse or pointer) a button indicative of an Excel spreadsheet file. The mailing address data allows the user to then print mailing addresses onto letters and envelopes for direct mailing. Optionally, the address data may be exported to a mailing company. The process of automatically generating cost segregation estimates and then mailing the estimates directly to property owners using the spreadsheet software is novel and represent an advancement of technology.

In one aspect, the asset management system 150, with user input, puts the sales files together as a marketing campaign. The user can then press one button to download as a single .pdf file, and then another button for generating an Excel file.

Returning to FIG. 10B, the method 1000 next comprises receiving a request from a prospective customer for cost segregation services. This is shown in Box 1070. The contact may be a telephone call, an e-mail, or via any other means offered by the user in the cover letter of Box 1060. The user will then arrange for a meeting with the prospective client as indicated in Box 1075.

As a next step in the method 1000, a determination is made as to whether the prospective client a qualified real estate investor. This is offered in Box 1080. In order to take advantage of the benefits provided under the Internal Revenue Code for cost segregation, the real estate owner must meet certain qualification. This will involve a number of considerations such as what taxes have been paid from a business associated with the real property asset, were those taxes sufficient or accurate, were the taxes paid on the correct property, was the real estate asset actually placed in service as a business when it was purchased, and so forth.

Once the prospective client is qualified, they can become a client and the process can proceed. It is understood that the qualification process under Box 1080 may and likely will involve the property owner's CPA and an analysis of the property owner's tax returns.

Once it is determined under Box 1080 that the property owner (or prospective client) is a qualified real estate investor under the Tax Code, a site inspection must be conducted. This is shown in box 1090. The site inspection includes an in-person (live or virtual) inspection of the real estate asset. From there, an engineering study is conducted and an engineering report is prepared. This is offered in Box 1095.

The engineer is typically a civil or mechanical engineer who conducts an investigation as to which portions of the real estate asset represent 5-year depreciation and which represent 15-year depreciation. This may be referred to as engineering breakdown. There are two different methods for the engineering breakdown. The first is a cost estimation engineering approach. The cost engineering approach determines essentially the difference between the cost of building the original structure with the cost of rebuilding the improved structure and property from the ground. The other approach involves an examination of the blueprints and construction records for how the structure and its improvements were constructed and how much it all cost.

In practice, the engineer's photographs, studies and reports or sent back to the user. In one aspect, the engineering report is added as a file associated with the Marketing Campaign 500. Further engineering work may be done to allocate aspects of the construction to either short term property or long term property. Short term property can either be 5-year or 15-year depreciation, while the long term property is 39-year depreciation. A final report is then prepared, representing a Cost Segregation Study. This is seen in Box 1100.

The Cost Segregation Study 1100 ultimately calculates how much of a deduction can be taken from the business which uses the property. The study seeks to determine the difference between a straight-line deduction that was taken by the owner, and the deduction that could be used under cost segregation. The amount of money that the owner saves as a result of the study, in one aspect, is determined by multiplying the owner's tax rate by the deduction. This is how much cash value the owner saves in taxes. These results are provided to the CPA along with a Tax Form 3115. This is a form used to change the accounting method.

The technology discussed herein makes reference to servers, databases, software applications, and other computer-based systems, as well as actions taken, and information sent to and from such systems. One of ordinary skill in the art will recognize that the inherent flexibility of computer-based systems allows for a variety of possible configurations, combinations, and divisions of tasks and functionality between and among components. For instance, server processes discussed herein can be implemented using a single server or multiple servers working in combination. Databases and applications can be implemented on a single system or distributed across multiple systems. Distributed components can operate sequentially or in parallel. Furthermore, computing tasks discussed herein as being performed at a server can instead be performed at a user device.

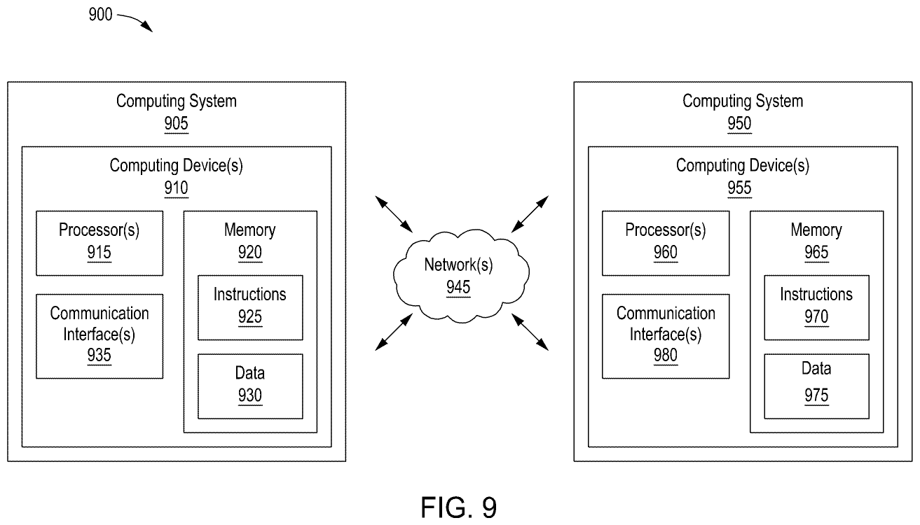

FIG. 9 is a schematic diagram of a computing system 900 that can be used to implement the method 800 for automatically generating a cost segregation estimate according to example embodiments of the present disclosure. The example system 900 includes a computing system 905 (e.g., asset management system 150) and a computing system 950 (e.g., one or more external sources 115 and one or more display devices 110), that are communicatively coupled over a network 945.

The computing system 905 can include one or more computing devices 910 (e.g., computing device 105). The computing device(s) 910 of the computing system 905 includes a processor 915 and memory 920. The processor 915 can be any suitable processing device (e.g., a processor core, a microprocessor, an ASIC, a FPGA, a controller, or a microcontroller) and can be one processor or a plurality of processors that are operatively connected. The memory 920 can include one or more non-transitory computer-readable storage media, such as RAM, ROM, EEPROM, EPROM, one or more memory devices, flash memory devices, and combinations thereof.

The memory 920 can store information that can be accessed by the processor 915. For instance, the memory 920 can include computer-readable instructions 925 that can be executed by the processor 915. The instructions 925 can be software written in any suitable programming language or can be implemented in hardware. Additionally, or alternatively, the instructions 925 can be executed in logically and/or virtually separate threads on the processor 915.

For example, the memory 920 can store instructions 925 that when executed by the processor 915 cause the processor 915 to perform operations such as any of the operations and functions for which the computing systems are configured, as described herein.

The memory 920 can store data 930 that can be obtained, received, accessed, written, manipulated, created, and/or stored. The data 930 can include, for instance, the asset database, historical database, asset data, asset profiles, and historical data as described herein. In some implementations, the computing device 910 can obtain from and store data in one or more memory device(s) that are remote from the computing system 905 such as one or more memory devices of the computing system 950.

The computing device 910 can also include a communication interface 935 used to communicate with one or more other systems (e.g., computing system 950). The communication interface 935 can include any circuits, components, or software for communicating via one or more networks 945. In some implementations, the communication interface 935 can include one or more of a communications controller, receiver, transceiver, transmitter, software and/or hardware for communicating data.

The computing system 950 can include one or more computing devices 955. The computing devices 955 can include one or more processors 960 and a memory 965. The processors 960 may be any suitable processing device such as a processor core, a microprocessor, an ASIC, a FPGA, a controller, or a microcontroller, and can be one processor or a plurality of processors that are operatively connected. The memory 965 can include one or more non-transitory computer-readable storage media, such as RAM, ROM, EEPROM, EPROM, one or more memory devices, flash memory devices, or combinations thereof.

The memory 965 can store information that can be accessed by the one or more processors 960. For instance, the memory 965 (e.g., one or more non-transitory computer-readable storage mediums, memory devices) can store data 975 that can be obtained, received, accessed, written, manipulated, created, and/or stored. The data 975 can include asset data, and/or other data described herein. The computing system 950 may obtain data from one or more memory device(s) that are remote from the computing system 950.

The memory 965 can also store computer-readable instructions 970 that can be executed by the one or more processors 960. The instructions 970 can be software written in any suitable programming language or can be implemented in hardware. Additionally, or alternatively, the instructions 970 can be executed in logically and/or virtually separate threads on the processor 960. For example, the memory 965 can store instructions 970 that when executed by the processor 960 cause the processor 960 to perform any of the operations and/or functions described herein.

The computing device(s) 955 can also include a communication interface 980 used to communicate with one or more other systems. The communication interface 980 can include any circuits, components, or software for communicating via one or more networks (e.g., 945). In some implementations, the communication interface 980 can include one or more of a communications controller, receiver, transceiver, transmitter, port, conductors, software and/or hardware for communicating data.

The network 945 can be any type of network or combination of networks that allows for communication between devices. In some embodiments, the network 945 can include one or more of a local area network, wide area network, the Internet, secure network, cellular network, mesh network, peer-to-peer communication link and/or some combination thereof and can include any number of wired or wireless links.

While the present subject matter has been described in detail with respect to specific example embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

I claim:

1. A computer-implemented method for generating a cost segregation study, comprising:
obtaining by a computer system comprising one or more computing devices, user input indicative of a selected real property asset from a user;
obtaining, from one or more databases in communication with the computer system, asset attributes associated with the selected real property asset, including the identity of the owner and contact information for the owner of the selected real property asset;
assigning a confidence score to at least one of the asset attributes obtained, wherein said confidence score represents a trustworthiness of the respective asset attribute obtained;
increasing the confidence score according to a determination that one of the following is true: (i) the asset attribute has a value that appears in more than one of the one or more databases, and (ii) the asset has a value that is reported by a trusted external source;
decreasing the confidence score according to a determination that one of the following is true: (i) the asset attribute has a value that is inconsistently reported by the one or more databases and (ii) the asset has a value that appears in only one of the one or more databases;
generating a digital representation of the selected real property asset including one or more of the asset attributes associated with the selected real property asset and having a confidence score that is above a confidence score threshold;
comparing at least one of the asset attributes associated with the selected real property asset to at least one asset attribute associated with at least one of a plurality of asset profiles, each of the plurality of asset profiles being associated with a corresponding real property asset for which cost segregation data indicative of one of a previous cost segregation study and a previous cost segregation estimate exists and is stored in a historical database for a comparable real property asset having one or more asset attributes that are similar to one or more of the selected real property asset attributes;
selecting from the historical database, historical segregation data associated with at least one additional real property asset according to the comparison of at least one real property attribute associated with the selected real property asset with at least one of the real property asset associated with the at least one of a plurality of real property asset profiles;
automatically generating, by the computing system, a holistic cost segregation estimate for the selected real property asset based, at least in part, on the digital representation of the selected real property asset and the historical segregation data associated with the at least on additional real property asset;
providing for display to the user, by the computing system, the holistic cost segregation estimate;
sending the holistic cost segregation estimate to the owner of the selected real property asset using the owner's contact information;
receiving a communication from the owner concerning cost segregation services;
conducting an on-site investigation of the selected real property asset;
based on the on-site investigation, generating a cost segregation study for the owner; and
associating the holistic cost segregation estimate with the selected real property asset and storing the associated holistic cost segregation estimate in the historical database so that the holistic cost segregation estimate is included as part of the historical segregation data associated with the selected real property asset.

2. The computer-implemented method of claim 1, wherein the one or more asset attributes associated with the selected real property asset comprise a use classification, and wherein generating the holistic cost segregation estimate comprises:
determining, by the computing system, use depreciation data for the selected real property asset based, at least in part, on the use classification and the historical segregation data; and
generating, by the computing system, the holistic cost segregation estimated based, at least in part, on the use depreciation data.

3. The computer-implemented method of claim 2, wherein the one or more attributes associated with the selected real property asset comprise an asset group classification, and wherein generating the holistic segregation estimate comprises:
determining, by the computing system, group depreciation data for the selected real property asset based, at least in part, on the asset group classification and the historical segregation data; and
generating, by the computing system, the holistic cost segregation estimate based, at least in part, on the group depreciation data.

4. The computer-implemented method of claim 3, wherein the asset group classification identified a respective asset group of a plurality of predefined asset groups, wherein each of the plurality of predefined asset groups is indicative of an association between one or more use classifications.

5. The computer-implemented method of claim 3, wherein generating a digital representation of the selected real property asset comprises:
determining, by the computing system, the asset group classification for the selected real property asset based, at least in part, on the one or more asset attributes corresponding to the selected real property asset.

6. The computer-implemented method of claim 3, wherein generating the holistic cost segregation estimate comprises:
determining, by the computing system, an optimal asset for the selected real property asset based, at least in part, on the digital representation;
determining, by the computing system, optimal depreciation data corresponding to the optimal asset; and
generating, by the computing system, the holistic cost segregation estimate based, at least in part, on the optimal depreciation data.

7. The computer-implemented method of claim 6, wherein the holistic cost segregation estimate comprises holistic depreciation data, and wherein generating the holistic segregation estimate comprises:
determining, by the computing system, the holistic depreciation data based, at least in part, on an average of the use depreciation data, the group depreciation data, and the optimal depreciation data.

8. The computer-implemented method of claim 7, wherein the holistic depreciation data comprises a five year depreciation average and a fifteen year depreciation average for the selected real property asset.

9. The computer-implemented method of claim 6, wherein the one or more selected real property asset attributes comprise a purchase price and an asset footprint indicative of at least one of a building size or a lot size, and wherein determining the optimal asset comprises:
determining, by the computing system, a similarity value for each of a subset of the plurality of asset profiles, at least in part, on a comparison between the purchase price or the asset footprint corresponding to the selected real property asset and a respective purchase price or asset footprint corresponding to each respective asset of subset of the plurality of asset profiles; and
determining, by the computing system, the optimal asset from the subset of assets based, at least in part, on the similarity value for each of the subset of the plurality of asset profiles.

10. The computer-implemented method of claim 1, further comprising:
automatically updating the asset attributes associated with at least one of the selected real property asset and at least one of the plurality of asset profiles, causing the computer system to communicate with one or more databases stored on one or more remote computing devices and to obtain additional information concerning one or more asset attributes associated with at least one of the selected real property asset and at least one of the plurality of asset profiles.

11. The computer-implemented method of claim 1, further comprising:
using the engineering study of the real property asset, filing an appropriate form with the Internal Revenue Service of the United States to change the depreciation basis of the real property asset.

12. The computer-implemented method of claim 11, further comprising:
conducting an engineering study of the real property asset to determine which portions of the selected real property asset are subject to 5-year depreciation and which portions of the selected real property asset are subject to 15-year depreciation.

13. A computing system configured for preparing a cost segregation estimate, the computing system comprising:
a digital representation of a first real property asset, including asset attributes associated with the first real property asset and having a confidence score that is above a confidence score threshold;
a historical database comprising historical segregation data indicative of a plurality of previous segregation studies for one or more of a plurality of real property assets;
one or more display devices;
one or more processors; and
one or more non-transitory computer-readable media that collectively store instructions that, when executed by the one or more processors, cause the system to perform operations, the operations comprising:
selecting from the historical database, historical segregation data associated with at least one additional real property asset according to a comparison of at least one real property asset attribute associated with the at least one additional real property asset with at least one of the real property asset attributes associated with the first real property asset;
automatically generating a holistic segregation estimate for the first real property asset based, at least in part, on the digital representation of the first real property asset and the historical segregation data associated with the at least one additional real property asset;
providing for display to the user, via the one or more display devices, a second user interface presenting at least one of the historical segregation data associated with the at least one additional real property asset, the digital representation of the first real property asset, and the holistic segregation estimate for the first real property asset;
associating the holistic cost segregation estimate with one or more of the real property asset attributes of the first real property asset and storing the associated holistic segregation estimate in the historical database, thereby improving the accuracy of the historical segregation data contained in the historical database;
in response to user input, generating a digital file comprising a plurality of real estate assets having selected asset attributes, wherein the attributes comprise the owners of the respective real estate assets and the contact information of the owners, wherein the digital file represents a Marketing Campaign; and
automatically sending cost segregation estimates to the owners listed in the Marketing Campaign using the contact information, wherein the cost segregation studies correlate to the respective owners and their real estate assets.

14. The computing system of claim 13, wherein the operations further comprise:
providing for display to the user, via the one or more display devices, a third user interface presenting one or more search criteria options;
obtaining, via the third user interface, query user input indicative of search criteria for the one or more of the plurality of assets; and
identifying the one or more of the plurality of assets based, at least in part, on the search criteria.

15. The computing system of claim 14, wherein:
the search criteria comprises at least one of location data, ownership data, price data, a group classification, a use classification, a footprint, or depreciation data; and
the computing system has sufficient RAM to generate the cost segregation estimates without being connected to a network.

16. The computing system of claim 15, wherein the asset profile comprises one or more asset attributes indicative of at least one of the location data, ownership data, price data, group classification, use classification, footprint, or depreciation data.

17. The computing system of claim 13, wherein the computing system is in communications with one or more databases stored on one or more remote computing devices and obtains asset attributes corresponding to the first real property asset from the one or more databases, and:
assigns a confidence score to each of the plurality of asset attributes corresponding to the first real property asset; and
generates the digital representation of the first real property asset based, at least in part, on the confidence score for each of the plurality of asset attributes corresponding to the first real property asset, wherein the digital representation of the first real property asset comprises one or more asset attributes associated with a respective confidence score above the confidence score threshold.

18. The computing system of claim 13, wherein the operations further comprise: in response to the selection user input:
providing for display to a user, via the one or more display devices, a fourth user interface presenting one or more user profile options for selection by the user;
obtaining, via the fourth user interface, user profile input indicative of a user profile option, wherein the user profile option is indicative of adding the first real property asset to a user profile.

19. The computing system of claim 18, wherein the second user interface presents at least one of a respective digital representation or a respective holistic cost segregation estimate for the first real property asset and each of a plurality of previously selected real property assets.

20. A computer-implemented method of preparing a cost segregation study, comprising:
obtaining, by a computing system comprising one or more computing devices, search criteria indicative of one or more real property asset attributes associated with at least one of a plurality of real property assets;
providing for display, by the computing system via one or more display devices, a first user interface presenting a visual representation of a plurality of digital representations, each of which is associated with a corresponding real property asset and together forming a Marketing Campaign, wherein each of the plurality of digital representations is stored on a database that is in communication with the computing system and includes one or more real property asset attributes associated with the corresponding real property asset and having a confidence score that is above a confidence threshold, and wherein the real property asset attributes comprise the identity of the respective owners and contact information for the owners of the real property assets in the Marketing Campaign;
automatically generating, by the computing system, a cost segregation estimate for each of the selected real property assets;
automatically sending each of the cost segregation estimates to the owners of the respective real property assets using the contact information of the corresponding owners;
receiving a communication from one or more of the owners concerning cost segregation services;
conducting on-site investigations of the real property assets of the one or more owners who have communicated; and
based on the on-site investigation, generating a cost segregation study for the real property assets of the one or more owners who have communicated.

21. The computer-implemented method of claim 20, further comprising:
storing, by the computing system in an accessible memory, data indicative of the selected real property asset and the segregation estimate.

22. The computer-implemented method of claim 21, wherein the accessible memory comprises a historical database comprising historical cost segregation data indicative of a plurality of previous cost segregation studies for one or more of the plurality of real property assets, and wherein the cost segregation estimate for each of the real property assets is automatically generated based, at least in part, on the historical segregation data.

23. The computer-implemented method of claim 21, further comprising:
storing, by the computing system in an accessible memory by pressing a single button, the Marketing Campaign in either .pdf file format or Xcel file format.

24. The computer-implemented method of claim 20, further comprising:
conducting an engineering study of the real property asset to determine which portions of the selected real property asset are subject to 5-year depreciation and which portions of the selected real property asset are subject to 15-year depreciation;
and wherein the cost segregation study is further based on the engineering study.
